(19) United States
(12) Patent Application Publication
(10) Pub. No.: US 2025/0298048 A1
(43) Pub. Date: Sep. 25, 2025

(54) SYSTEMS, METHODS, AND DEVICES FOR PATHOGEN IDENTIFICATION

(71) Applicant: Deepull Diagnostics S.L., Barcelona (ES)

(72) Inventors: Rafael BRU GIBERT, Barcelona (ES); Jordi CARRERA FABRA, Barcelona (ES); Clara COSGAYA CASTRO, Barcelona (ES); Verónica MARTÍNEZ MOLINER, Barcelona (ES)

(73) Assignee: Deepull Diagnostics S.L., Barcelona (ES)

(21) Appl. No.: 18/728,775

(22) PCT Filed: Jan. 13, 2023
(86) PCT No.: PCT/IB2023/050338

§ 371 Date: Jul. 12, 2024

Related U.S. Application Data
(60) Provisional application No. 63/299,611, filed on Jan. 14, 2022.

(51) Int. Cl. G01N 35/10; B01L 3/00; G01N 35/00

(52) U.S. Cl. CPC G01N 35/1009; B01L 3/5082; B01L 3/52; B01L 2200/0631; B01L 2200/0647; B01L 2200/0684; B01L 2200/0689; B01L 2200/10; B01L 2200/141; B01L 2200/16; B01L 2300/041; B01L 2300/0681; G01N 2035/00495; G01N 2035/00524

(57) ABSTRACT

Described herein are systems, methods, and devices for pathogen identification. A system includes a housing configured to receive a sample comprising pathogen(s), a pipettor system disposed inside the housing, centrifuge(s) disposed inside the housing, a mechanical agitator disposed inside the housing, and a controller. The controller is configured to transfer the sample to a processing tube using the pipettor system, centrifuge the processing tube using the centrifuge(s) to concentrate the pathogen(s) in the sample, remove a fluid from the processing tube using the pipettor system, leaving the concentrated pathogens in the processing tube, add a lysis buffer to the processing tube using the pipettor system, move the processing tube to the mechanical agitator using the pipettor system, and agitate the processing tube using the mechanical agitator to perform lysis of the concentrated pathogens. The system is further configured to perform PCR using a nucleic acid extracted from the sample.

### CROSS-REFERENCE TO RELATED APPLICATIONS

This application claims the benefit of U.S. Provisional Application No. 63/299,611, filed Jan. 14, 2022, which is incorporated herein by reference in its entirety. This application is related to co-pending PCT Patent Application No. PCT/IB2023/050337, filed on Jan. 13, 2023, and PCT Application No. PCT/US2022/039290, filed on Aug. 3, 2022, the disclosures of which are incorporated by reference herein in their entireties.

### BACKGROUND

### Field

Embodiments of the present disclosure relate to systems, methods, and devices for performing pathogen identification and/or identification of resistance genes from whole blood or other samples to assist in determining treatment of patients.

### Background

Sepsis is defined as life-threatening organ dysfunction caused by a dysregulated host response to infection. A patient experiencing or undergoing sepsis may start with a local infection, such as pneumonia, that results in inflammation of the body from the patient's immune system going into overdrive. Inflammation may ultimately lead to organ failure and death of the patient if left untreated. Sepsis causes 11 million deaths annually, and many of these cases can be prevented by early diagnosis, proper clinical management, and treatment.

Sepsis diagnosis may be performed by running laboratory tests to culture blood samples for identifying infection. Current testing times may take several days to obtain results from a laboratory as a result of the time needed for obtaining and processing blood cultures for sepsis-causing bacteria to ultimately determine its susceptibility to effective antimicrobials for treatment. However, sepsis detection may be time-sensitive for patients In a hospital, because sepsis can lead to septic shock and death within hours if not properly identified and treated in time. Additionally, blood culture testing is slow and might not consistently provide reliable results of bacteria or fungi detection in patients who are clinically suspected of having sepsis, especially for patients already undergoing antibiotic therapy. There is often a low yield for obtaining positive blood cultures for patients, and patients may be experiencing sepsis even without the identification of a positive blood culture.

Without improved solutions, patients may continue to suffer and often becomes worse as physicians treat with empiric antibiotics while awaiting more actionable information from the laboratories about the one or more causative agents for the infection (e.g., pathogens) and with which antimicrobials to treat highly resistant pathogens in patients undergoing sepsis.

### BRIEF SUMMARY

Embodiments of the present disclosure provide cost-effective solutions for improved diagnostic methods, systems, and devices for isolating and identifying pathogens in order to provide appropriate treatments to patients for better patient outcomes.

Described herein are systems, methods, and devices for pathogen identification directly from blood samples, or other samples, such as urine, sterile body fluids, or the like. In the embodiments presented herein, pathogen identification systems, analyzer devices, polymerase chain reaction (PCR) cartridges, sample preparation cartridges, and processing tubes are provided for conducting pathogen identification and determination of resistance genes from whole blood samples, without a culture step, and by using a multiplex PCR approach and significantly reducing the analysis time. The pathogen identification includes transferring samples into consumables for further processing (e.g., nucleic acid extraction, purification and amplification) using pipetting systems, concentration of pathogens, lysis of pathogens (e.g., by mechanical disruption), purification of nucleic acid from pathogens, and amplification and identification of pathogens by nested PCR. In some embodiments, the systems, methods, and devices for pathogen identification described herein may be used to treat patients with sepsis and/or other underlying diseases.

In an embodiment, an example sample preparation cartridge is described. The sample preparation cartridge includes a housing, a removable processing tube disposed inside the housing, a first removable needle disposed inside the housing, and one or more reservoirs coupled to the housing. The removable processing tube comprises a septum and is configured to hold a sample. The first removable needle is configured to transfer the sample to and/or from the removable processing tube by insertion of the first removable needle through the septum. The one or more reservoirs are configured to store materials used for performing sample concentration, lysis, and nucleic acid amplification.

In another embodiment, an example system analyzing samples is described. The system includes a housing configured to receive a sample tube containing a sample comprising one or more pathogens, a pipettor system disposed inside the housing, one or more centrifuges disposed inside the housing, a mechanical agitator disposed inside the housing, and a controller. The controller is configured to transfer the sample from the sample tube to a processing tube using the pipettor system, centrifuge the processing tube using the one or more centrifuges to concentrate the one or more pathogens in the sample, remove a fluid from the processing tube using the pipettor system, leaving the concentrated pathogens in the processing tube, add a lysis buffer to the processing tube using the pipettor system, move the processing tube to the mechanical agitator using the pipettor system, and agitate the processing tube using the mechanical agitator to perform cell lysis of the concentrated pathogens.

In another embodiment, an example method is described. The method includes receiving, by an analyzer device, a sample preparation cartridge and a sample tube, the sample tube containing a sample comprising one or more pathogens, installing a first needle from the sample preparation cartridge in a pipettor system in the analyzer device, inserting the first needle into the sample tube using the pipettor system, transferring the sample from the sample tube through the first needle to a processing tube in the sample preparation cartridge, adding one or more lysis reagents to the processing tube using the pipettor system, and mixing the one or more lysis reagents with the sample in the processing tube to lyse blood cells in the sample. The method further includes moving the processing tube to a centrifuge in the analyzer device, centrifuging the processing tube in the centrifuge to concentrate the one or more pathogens in the sample, removing a fluid from the processing tube using the pipettor system, leaving the concentrated pathogens in the processing tube, adding a lysis buffer to the processing tube using the pipettor system, moving the processing tube to an apparatus in the analyzer device using the pipettor system, and agitating the processing tube using the apparatus to perform cell lysis of the concentrated pathogens.

In another embodiment, an example method is described. The method includes transferring, by a pipettor system in an analyzer device, a nucleic acid to at least one primary reaction chamber in a polymerase chain reaction (PCR) cartridge inserted in the analyzer device, performing a first amplification of the nucleic acid in the at least one primary reaction chamber, resulting in a first amplified product, and inserting a needle of the analyzer device through a septum of the at least one primary reaction chamber to remove the first amplified product. The method further includes dispensing a plurality of aliquots of the first amplified product to a plurality of secondary reaction chambers in the PCR cartridge through respective septums of the plurality of secondary reaction chambers, wherein each aliquot corresponds to a respective secondary reaction chamber, and wherein each secondary reaction chamber comprises a set of reagents for reacting with the respective aliquot of the first amplified product, and performing a second amplification of the aliquots of the first amplified product in the plurality of secondary reaction chambers.

In another embodiment, an example polymerase chain reaction (PCR) cartridge is described. The PCR cartridge comprises at least one primary reaction chamber configured to perform a first amplification of a nucleic acid, resulting in a first amplified product, and a plurality of secondary reaction chambers configured to perform a second amplification of the product nucleic acid. The at least one primary reaction chambers and the plurality of secondary reaction chambers are each sealed with a septum. The septum is configured to receive a needle, and each secondary reaction chamber in the plurality of secondary reaction chambers is configured to receive a respective aliquot of the first amplified product from the needle. Each secondary reaction chamber comprises a set of reagents for reacting with the respective aliquot of the first amplified product.

Further features and advantages, as well as the structure and operation of various embodiments, are described in detail below with reference to the accompanying drawings. It is noted that the specific embodiments described herein are not intended to be limiting. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the pertinent art to make and use the disclosure.

FIG. 1 illustrates a diagram of a system for performing pathogen identification, according to embodiments of the present disclosure.

FIG. 2 illustrates a diagram of an analyzer device, according to embodiments of the present disclosure.

FIG. 3A illustrates a diagram of a front view of an analyzer device, according to embodiments of the present disclosure.

FIG. 3B illustrates a diagram of a top view of an analyzer device, according to embodiments of the present disclosure.

FIG. 4 illustrates a diagram of an analyzer device with three opening compartments, according to embodiments of the present disclosure.

FIG. 5 illustrates a diagram of a sample preparation cartridge, according to embodiments of the present disclosure.

FIG. 6A illustrates a diagram of a processing tube and other components within the sample preparation cartridge, according to embodiments of the present disclosure.

FIG. 6B illustrates a diagram of a processing tube and other components within a linear sample preparation cartridge, according to embodiments of the present disclosure.

FIGS. 7A and 7B illustrate diagrams of a processing tube, according to embodiments of the present disclosure.

FIGS. 7C and 7D illustrates diagrams of an example reagent tube, according to embodiments of the present disclosure.

FIGS. 8A, 8B, and 8C illustrate diagrams of a needle configured for insertion into a processing tube and/or reagent tube, according to embodiments of the present disclosure.

FIGS. 9A and 9B illustrate diagrams of a high volume needle and a low volume needle, respectively, according to embodiments of the present disclosure.

FIG. 10 illustrates a diagram of examples of a high volume needle, according to embodiments of the present disclosure.

FIGS. 11A and 11B illustrate diagrams of a spin column and spin column basket, according to embodiments of the present disclosure.

FIG. 12A illustrates a diagram of a low volume needle interfacing with a sample preparation cartridge, according to embodiments of the present disclosure.

FIG. 12B illustrates a low volume needle interfacing with a spin column basket, according to embodiments of the present disclosure.

FIGS. 13A and 13B illustrate diagrams of a PCR cartridge, according to embodiments of the present disclosure.

FIG. 14 illustrates a diagram of a low volume needle being inserted into a PCR cartridge, according to embodiments of the present disclosure.

FIGS. 15A and 15B illustrate diagrams of example centrifuges used in an analyzer, according to embodiments of the present disclosure.

FIGS. 16A, 16B, 16C, and 16D illustrate diagrams of an example homogenization subsystem used in an analyzer, according to embodiments of the present disclosure.

FIGS. 17A, 17B, and 17C illustrate diagrams of an example mechanical apparatus used in an analyzer, according to embodiments of the present disclosure.

FIGS. 18A-C illustrate a PCR cartridge interfacing with a fluorescence sensor in the PCR subsystem in the analyzer, according to embodiments of the present disclosure.

FIGS. 19A-B further illustrate a PCR cartridge interfacing with a fluorescence sensor in the PCR subsystem in the analyzer, according to embodiments of the present disclosure.

FIG. 20 illustrates a flowchart diagram of a method for performing sample processing, including concentration and lysis of a sample, before pathogen identification, according to embodiments of the present disclosure.

FIG. 21 illustrates a flowchart diagram of a method for performing PCR for pathogen identification of a sample, according to embodiments of the present disclosure.

FIG. 22 illustrates a block diagram of example components of a computer system, according to embodiments of the present disclosure.

FIGS. 23-29 illustrate experimental results from tests based on embodiments of the present disclosure.

Embodiments of the present disclosure will be described with reference to the accompanying drawings.

### DETAILED DESCRIPTION

Although specific configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that this disclosure can also be employed in a variety of other applications.

Units, prefixes, and symbols are denoted in their Système International de Unites (SI) accepted form. Numeric ranges are inclusive of the numbers defining the range. Where a range of values is recited, it is to be understood that each intervening integer value, and each fraction thereof, between the recited upper and lower limits of that range is also specifically disclosed, along with each subrange between such values. Thus, ranges recited herein are understood to be shorthand for all of the values within the range, inclusive of the recited endpoints. For example, a range of 1 to 10 is understood to include any number, combination of numbers, or sub-range from the group consisting of 1, 2, 3, 4, 5, 6, 7, 8, 9, and 10.

Where a value is explicitly recited, it is to be understood that values which are about the same quantity or amount as the recited value are also within the scope of the disclosure. Where a combination is disclosed, each subcombination of the elements of that combination is also specifically disclosed and is within the scope of the disclosure. Conversely, where different elements or groups of elements are individually disclosed, combinations thereof are also disclosed.

The use of the alternative (e.g., “or”) should be understood to mean either one, both, or any combination thereof of the alternatives. As used herein, the indefinite articles “a” or “an” should be understood to refer to “one or more” of any recited or enumerated component.

The term “about” refers to a value or composition that is within an acceptable error range for the particular value or composition as determined by one of ordinary skill in the art, which will depend in part on how the value or composition is measured or determined, i.e., the limitations of the measurement system. For example, “about” can mean within 1 or more than 1 standard deviation per the practice in the art. Alternatively, “about” can mean a range of up to 10%. Furthermore, particularly with respect to biological systems or processes, the terms can mean up to an order of magnitude or up to 5-fold of a value. When particular values or compositions are provided in the application and claims, unless otherwise stated, the meaning of “about” should be assumed to be within an acceptable error range for that particular value or composition.

As described herein, any concentration range, percentage range, ratio range or integer range is to be understood to include the value of any integer within the recited range and, when appropriate, fractions thereof (such as one tenth and one hundredth of an integer), unless otherwise indicated.

### INTRODUCTION

The current standard of care for detecting and treating sepsis relies on blood culture, for which the average time to detection is about 13 hours. Blood culture testing supplies an organism, without identification (ID) of the pathogen, followed by plating of positives on petri dishes. In a conventional blood culture process, two blood culture sets are taken per adult patient, in which each set consists of an aerobic bottle and an anaerobic bottle to assure that the entire spectrum of sepsis causative bacteria is captured during the culture event. Generally, each culture is acquired from a separate venipuncture (e.g., left arm and right arm of the patient). This is to assure that the bacterial shedding event is captured by the culture so that the bacteria may be “recovered” for downstream testing (e.g., ID and AST). Following the culturing, the aerobic and anaerobic bottles are incubated in a blood culture instrument where they are monitored in real-time for growth. The aerobic and anaerobic bottles are incubated and agitated until any bacteria is allowed to go through a lag-log growth transition that is detected electronically. A laboratory worker may then be alerted that a positive culture exists for the patient. Typically, a blood culture will become positive in an average of about 13 hours for most bacteria, while some yeasts and fungi may take much longer (e.g., up to 5 days). However, many cultures are negative due to collection error, an insufficient blood volume taken during collection, transport delays to the lab, insufficient sensitivity, or the like.

Due to the urgent nature of sepsis, following positivity, a laboratory may immediately commence a work-up to identify the bacterial gram stain (e.g., gram positive or gram negative), determine a significant organism, contaminant, single microbe, or polymicrobial infection, and report the intermediate information to the caregiver. Further, the lab may take immediate steps to identify the bacteria using rapid methods such as molecular diagnostics systems, which may take 1.5 hours to provide results. These systems may offer limited molecular information on genetic drug resistance information of certain bacteria that exhibit these profiles. Alternatively, the lab may process the positive blood culture (PBC) aliquot with a matrix-assisted laser desorption/ionization time of flight (MALDI-TOF) mass spectrometry system to report an ID in about one hour. Using the ID, the caregiver may confirm or potentially adjust antibiotics that may have been administered to the patient prophylactically. However, by the time the bacteria has been identified, up to 20-24 hours (at best) may have already passed since the patient was first cultured.

The overall process for detecting a positive blood culture sample and identifying a pathogen may be time-consuming, resulting in several days before critical antibiotic information is reported for sepsis patients. For example, if an infection is suspected, a sample of blood, urine, sputum, or the like, is collected from the patient and provided to a clinical laboratory to first determine if an infectious agent is present. This may require 18-24 hours (e.g., day 1) for most pathogenic bacterial species to sufficiently grow. If a bacterium is isolated, it further requires an additional 18-24 hours (e.g., day 2) to culture the isolate and another 2-48 hours (e.g., day 3+) to identify the bacterial isolate and perform AST.

Conventional methods and systems for pathogen identification may be limited because they are growth-based, slow, expensive, require manual manipulation, and are not integrated. Current technologies do not provide an integrated and comprehensive solution for the entire workflow of host response detection, pathogen identification, and antimicrobial or antibiotic susceptibility testing (AST). In some cases, some systems focus solely on identifying a single aspect of the sepsis cascade, such as detection of host response or detection of a pathogen. For example, a system may look at host response for early indication of sepsis by detecting molecular white cell RNA markers (via reverse transcription (RT)-PCR to detect gene expression), but would not provide answers for pathogen identification or susceptibility. The immune response result may alert caregivers that a patient is entering or has entered the sepsis cascade and is in urgent need of treatment or intervention to prevent further probability of irreversible morbidity. Caregivers may immediately react by looking for the infection site and the infectious agent using traditional methods, such as by obtaining blood cultures from the infection site to identify the infectious agent.

On the pathogen detection side, current technologies may offer a direct from blood detection and identification method, using PCR from blood samples and followed by detection. However, such systems may be expensive, limited in menu options, and difficult to service without providing a solution for rapid identification results, instead offering a limited molecular genetic resistance panel. Other systems may utilize direct-from-blood pathogen rRNA RT-PCR for pathogen identification but may also be constrained by a limited menu (e.g., 15 targets or less). Ultimately, current technologies do not provide an automated direct-from-blood rapid identification solution, and instead rely on positive blood cultures for testing which can take 13-20 hours to report anything actionable. For example, some systems may obtain aliquots from positive blood culture (PBC) bottles, thus saving the time needed to grow the bacterial isolate from the PBC bottle (e.g., 6-24 hours). These systems, however, are limited as to the numbers of drugs and organisms they can report on and thus have limited utility for healthcare providers.

In order to greatly reduce morbidity and mortality, new diagnostic methods, devices, and systems are needed for rapidly detecting infectious sepsis-causing bacteria at the single cell or low copy number level directly from a blood sample without the significant time delay required for the multiple culture steps (e.g., biological amplification) currently required by the standard of care methods. Thus, systems, devices, and methods described herein provide a holistic and systematic approach identifying pathogens in order to determine pathogen resistance and recommend treatments that are effective and appropriate for patients.

### Pathogen Identification System Overview:

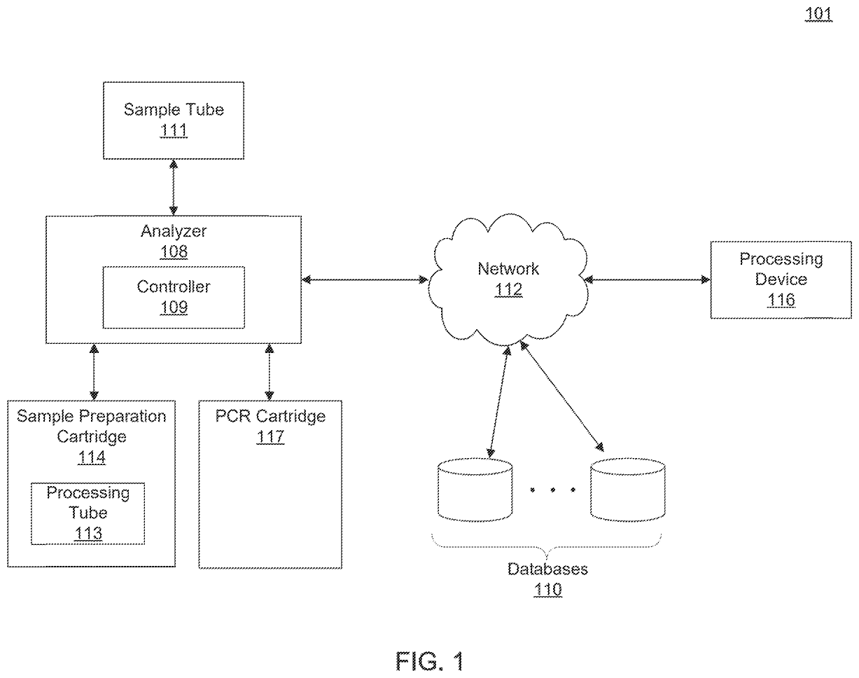

FIG. 1 illustrates a diagram of a system 101 for performing pathogen identification, according to embodiments of the present disclosure. In some embodiments, the system 101 may be referred to herein as a pathogen identification system 101 or a polymerase chain reaction (PCR) system 101. The system 101 may comprise an analyzer 108, a sample tube 111, sample preparation cartridge 114, PCR cartridge 117, processing device 116, and a plurality of databases 110 communicatively coupled via a network 112.

The analyzer 108 may be a point-of-care (POC) testing device that performs identification of pathogens in a sample of a patient, which may be stored in sample tube 111. In some embodiments, the analyzer 108 may be referred to herein as an analyzer device. In some embodiments, the sample in sample tube 111 may comprise whole blood, urine, sterile body fluids, or other samples obtained from the patient. In some embodiments, the analyzer 108 may receive the sample tube 111, which is placed into a corresponding drawer in a housing of the analyzer 108 by a user or operator of the analyzer 108.

In addition to receiving the sample tube 111, the analyzer 108 may also receive the sample preparation cartridge 114 and PCR cartridge 117, which may similarly be placed into corresponding drawers of the housing of the analyzer 108 by a user or operator of the analyzer 108. In some embodiments, various components and subsystems in the analyzer 108 may interface with the sample tube 111, sample preparation cartridge 114, PCR cartridge 117, processing device 116, and/or databases 110 to perform sample preparation and processing including cell lysis, concentration of pathogens in samples, and nucleic acid amplification using PCR and fluorescence readings.

In some embodiments, after receiving the sample tube 111, a pipetting system in the analyzer 108 may transfer the sample from the sample tube 111 to the sample preparation cartridge 114. In some embodiments, the sample preparation cartridge 114 may be a specialized consumable with receptacles configured to hold the sample and elements for performing sample processing. The sample preparation cartridge 114 may include a processing tube 113 that has a septum disposed over or within the tube for protecting contents therein. The processing tube 113 may be configured to receive the sample from the sample tube 111 through the septum, by using a needle of the sample preparation cartridge 114 to transfer the sample. Once the sample is transferred to the processing tube 113, the sample may undergo sample concentration, lysis, and/or other processing steps.

After sample preparation and processing (e.g., including concentration and lysis of the sample) using elements and components of the sample preparation cartridge 114, the sample is transferred from the processing tube 113 in the sample preparation cartridge 114 to the PCR cartridge 117 by the pipetting system in the analyzer 108. In some embodiments, the PCR cartridge 117 may be a specialized consumable with one or more primary reaction chambers and a plurality of secondary reaction chambers for performing nucleic acid amplification steps for pathogen identification. In some embodiments, the one or more primary reaction chambers of the PCR cartridge 117 may be configured to receive a nucleic acid, and the plurality of secondary reaction chambers of the PCR cartridge 117 may be configured to receive aliquots of a first amplified product after an amplification of the nucleic acid in the one or more primary reaction chambers. In some embodiments, the analyzer 108 may perform nucleic acid amplification in the PCR cartridge 117 and use a PCR subsystem disposed within the analyzer 108 to perform thermal cycling and detection of fluorescence signals generated during amplification. In some embodiments, one or more single step PCRs may be performed. In some embodiments, the one or more single step PCRs may utilize one or more primary reaction chambers in the PCR cartridge 117. In some embodiments, the one or more single step PCRs may utilize the secondary reaction chambers in the PCR cartridge 117, in which an initial sample is divided into the aliquots for performing the single step PCR.

In some embodiments, the analyzer 108 may further interface with additional cartridges, such as antimicrobial susceptibility testing (AST) cartridge. In some embodiments, the AST cartridge may be a specialized consumable with a plurality of reaction wells configured to hold a plurality of aliquots of an enriched sample for performing AST. In some embodiments, the analyzer 108 may be configured to hold one or more sample preparation cartridges 114, PCR cartridges 117, and/or AST cartridges at a time for performing sample preparation/processing, pathogen identification, and/or susceptibly testing concurrently or consecutively. In some embodiments, the sample preparation cartridge 114, AST cartridge, and/or PCR cartridge 117 may be referred to herein as consumables or containers configured for insertion into the analyzer 108.

In some embodiments, the analyzer 108 may include a controller 109 that is disposed inside the housing of the analyzer 108. The controller 109 may control movements and operations of different components within the analyzer 108, including movements of one or more sample tubes, processing tubes, cartridges, and pipetting systems in the analyzer 108. In some embodiments, the controller 109 may also control operations of one or more centrifuges, subsystems, and modules in the analyzer 108 for performing sample preparation, pathogen identification, susceptibility testing, and/or other functions. In some embodiments, the controller 109 may include a microcontroller on an integrated circuit (IC) chip in the analyzer 108 that is programmed is turn on/off and operate one or more centrifuges, subsystems, and modules in the analyzer 108. In some embodiments, the controller 109 may be coupled to one or more stepper motors, actuators, or other motion control components in the analyzer 108 and programmed to control movements.

In some embodiments, the controller 109 may be programmed by the processing device 116. The processing device 116 may be a computing device coupled to the analyzer 108 for performing data processing and providing instructions to the controller 109 and/or other components in the analyzer 108. In some embodiments, the processing device 116 may be a personal digital assistant, desktop workstation, laptop or notebook computer, netbook, tablet, smart phone, mobile phone, smart watch, or any combination thereof

In some embodiments, the processing device 116 may communicate with the analyzer 108 to receive results of the reactions occurring in the PCR cartridge 117 and perform further processing and data analysis for identification of one or more pathogens in the sample. In some embodiments, the processing device 116 may receive, from a PCR subsystem in the analyzer 108, fluorescence data of one or more signals generated in the PCR cartridge 117 from amplified nucleic acids and analyze the fluorescence data to identify a pathogen present in the sample of the patient based on the detected amplified nucleic acid.

In some embodiments, the processing device 116 may also communicate with the plurality of databases 110. In some embodiments, one or more of the plurality of databases 110 may represent any number of databases, and may include various databases that store clinical parameters data, epidemiology information or antibiotic resistance information for a plurality of pathogens, or the like. In some embodiments, one or more of the plurality of databases 110 may be configured to store pathogen taxonomy data and/or outcomes from previous pathogen identification workflows (e.g., performed by analyzer 108). In some embodiments, one or more of the plurality of databases 110 may comprise electronic health record (EHR) data comprising patient healthcare information obtained from various healthcare services and healthcare providers, such as hospitals, clinical care facilities, laboratories, radiology providers, and pharmacies.

In some embodiments, the EHR data stored in the databases 110 may comprise patient data and medical history data regarding the health and treatment of patients, including demographics, medical history, medication and allergies, immunization status, laboratory test results, radiology images, vital signs, personal statistics like age and weight, and billing information for each patient. In some embodiments, the processing device 116 may use results from pathogen identification and/or AST performed by the analyzer 108, along with data stored in the plurality of databases 110 (e.g., clinical parameters data, epidemiology information or antibiotic resistance information, EHR data, or the like) to determine treatment recommendations for patients.

In some embodiments, the components in system 101 may be communicatively coupled via network 112. In particular, the network 112 may allow transmission of information and communication between the analyzer 108, the plurality of databases 110, processing device 116, and/or any other devices or components in the system 101. In some embodiments, the system 101 may include additional components, such as a Raman spectroscopy device and/or electronic health record (EHR) system (not shown).

In some embodiments, network 112 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the analyzer 108, the plurality of databases 110, processing device 116, and/or any other devices or components in the system 101.

### Analyzer Device Embodiments

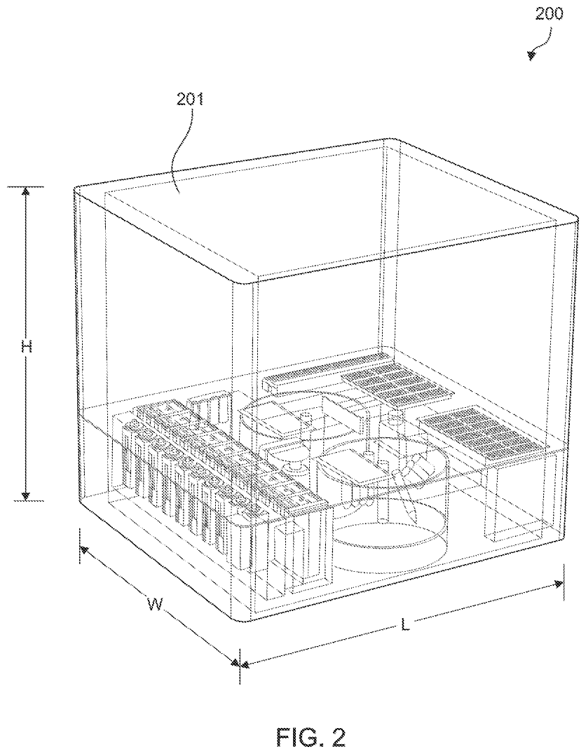

FIG. 2 illustrates a diagram of an analyzer device 200, according to embodiments of the present disclosure. Analyzer device 200 represents an exemplary embodiment of analyzer 108 shown in FIG. 1. In some embodiments, the analyzer device 200 may be referred to herein as an analyzer 200. The analyzer device 200 is a bench-top device with a housing 201, in which various components and modules for performing sample preparation, processing, and testing are housed. In some embodiments, the housing 201 may comprise a body of the analyzer device 200 and/or an exterior case of the analyzer device 200 that protects the modules and components within. In some embodiments, the analyzer device 200 may comprise a cubical, cuboid, or rectangular shape with various compartments for access and operation by a user of the analyzer device 200. In some embodiments, the analyzer device 200 may have a compact size with dimensions of less than about 1 m³, for example about 750 mm (length)×650 mm (width)×650 mm (height).

In some embodiments, the analyzer device 200 may be coupled to a computing device (e.g., processing device 116), such as a personal digital assistant, desktop workstation, laptop or notebook computer, netbook, tablet, smart phone, mobile phone, smart watch, or any combination thereof. A user or operator of the analyzer device 200 may use the computing device to control the analyzer device 200, send/receive sample information, patient information, pathogen information, antimicrobial information, or the like to/from the analyzer device 200, and access/edit results of the pathogen detection from the analyzer device 200.

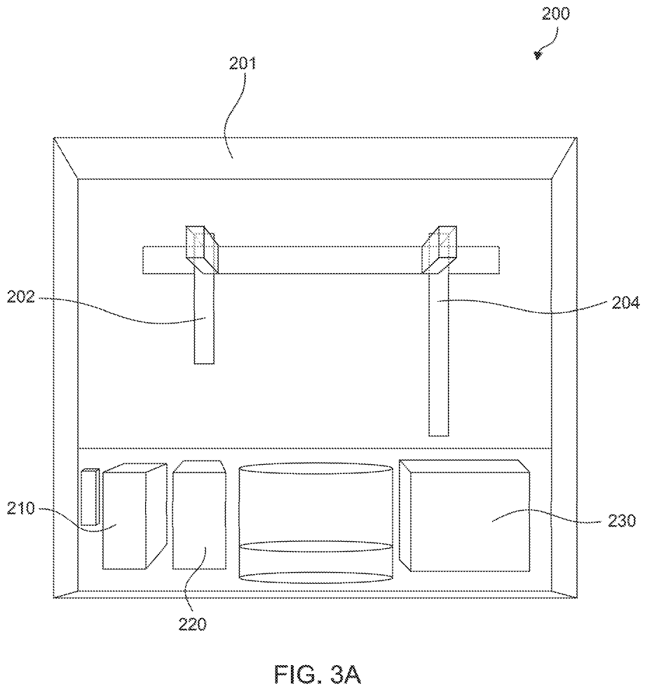

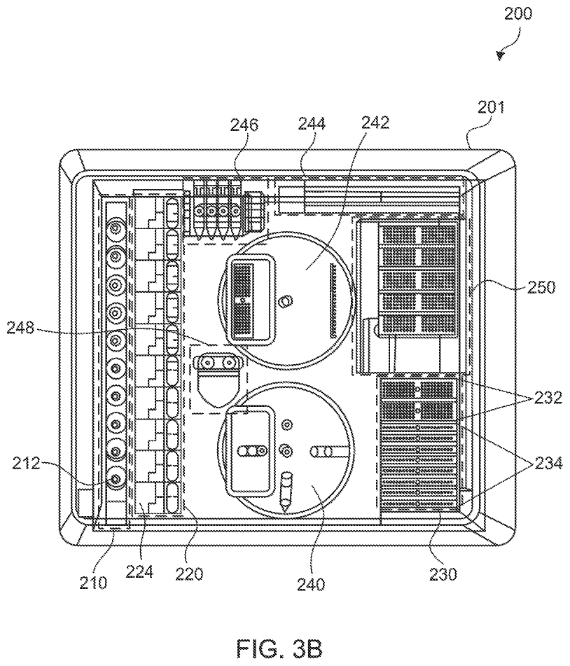

FIG. 3A illustrates a diagram of a front view of the analyzer device 200, according to embodiments of the present disclosure. FIG. 3A illustrates internal features arranged within housing 201 of the analyzer device 200, including first pipettor 202, second pipettor 204, sample drawer 210, sample cartridge drawer 220, and processing cartridge drawer 230.

In some embodiments, the first pipettor 202 and the second pipettor 204 may be pipettor devices configured to handle liquid transfer between components within the housing 201 of the analyzer device 200. In some embodiments, the first and second pipettors 202, 204 may be automated devices that are controlled by the controller 109 in the analyzer device 200. In some embodiments, the controller 109 may control movements of the first and second pipettors 202, 204, including vertical and/or horizontal movements of the first and second pipettors 202, 204 to and/or from different components within the analyzer device 200. In some embodiments, more or fewer pipettors may be present in the analyzer device 200.

In some embodiments, the first pipettor 202 and the second pipettor 204 may be referred to as a high volume pipettor and a low volume pipettor, respectively. In some embodiments, the first pipettor 202 may be configured to handle a volume in a range of about 50 microliters (μL) to 5 milliliters (mL), whereas the second pipettor 204 may be configured to handle a volume in a range of about 1 to 200 μL. In some embodiments, the first pipettor 202 may have a 5% coefficient of variation (CV) at 50 μL and a 1% CV at 5 mL, and the second pipettor 204 may have a 5% CV at 1 to 200 μL.

In some embodiments, the first and second pipettors 202, 204 may be referred to herein as pipettes and/or pipettor systems. In some embodiments, the first and second pipettors 202, 204 may each be configured to attach to needles that are removable and disposable. The first and second pipettors 202, 204 may attach to two different needles configured to handle different volume ranges as necessitated by the first and second pipettors 202, 204.

In addition to liquid transfer, the first and second pipettors 202, 204 may be configured to move elements, such as tubes, cartridges, or the like, within the housing 201 of the analyzer device 200. In particular, the first and second pipettors 202, 204 may each comprise a pipette tip holder that may attach to various components used in the analyzer device 200. In particular, the pipette tip of the first and second pipettors 202, 204 may press and fit into handling features of needles, tubes, cartridges, spin column baskets, and the like, to pick up various components and place them in different modules or areas in the analyzer device 200.

In some embodiments, the dimensions of the first and second pipettors 202, 204 may be about 325 mm (width)×575 mm (depth)×435 mm (height). In some embodiments, the first and second pipettors 202, 204 may be arranged in a top section of the housing 201, such that the first and second pipettors 202, 204 may interact with the samples, tubes, cartridges, and different modules in the bottom section of the housing 201. In particular, the first and second pipettors 202, 204 may handle liquid transfer and movement of components in the sample drawer 210, sample cartridge drawer 220, and processing cartridge drawer 230 shown in FIG. 3A.

In some embodiments, the sample drawer 210, sample cartridge drawer 220, and processing cartridge drawer 230 comprise sliding horizontal compartments that are designed to fit within three corresponding receptacles in the housing 201 of the analyzer device 200. In some embodiments, the sample drawer 210, sample cartridge drawer 220, and the processing cartridge drawer 230 may be configured to receive specialized elements that are inserted into the analyzer device 200 for sample processing and testing. In particular, the sample drawer 210 may receive a sample tube (e.g., sample tube 111) containing a sample obtained from a patient. The sample cartridge drawer 220 may receive a sample preparation cartridge (e.g., sample preparation cartridge 114), to which the sample is transferred by components in the analyzer device 200.

In some embodiments, the processing cartridge drawer 230 may receive a PCR cartridge (e.g., PCR cartridge 117) that is configured to receive a nucleic acid isolated from a sample after sample processing, pathogen concentration and lysis, and purification of a nucleic acid from the pathogens of the sample in the sample preparation cartridge. In additional or alternative embodiments, the processing cartridge drawer 230 may be used as an AST cartridge and/or a PCR cartridge drawer. For example, a PCR cartridge or an AST cartridge may be inserted in the processing cartridge drawer 230 depending on whether the analyzer device 200 is being used to perform pathogen identification or antimicrobial susceptibility testing of a sample. In some embodiments, the analyzer device 200 may be configured to perform both functionalities of pathogen identification and antimicrobial susceptibility testing with a dual processing cartridge drawer 230 that configured to interface with specialized cartridges or consumables for AST and pathogen identification.

In some embodiments, the sample drawer 210, sample cartridge drawer 220, and processing cartridge drawer 230 may each include a reader configured to scan an identifier of a sample tube, sample preparation cartridge, and PCR cartridge (or AST cartridge), respectively. In some embodiments, the readers in the drawers may scan the identifiers of the sample tubes and/or cartridges during insertion of each drawer into the housing 201 of the analyzer device 200. In some embodiments, the readers in the drawers 210, 220, and 230 may be configured to scan identification codes, barcodes, or data matrices of corresponding sample tubes and/or cartridges. In some embodiments, the readers in the drawers 210, 220, and 230 may be barcode readers, quick response (QR) code readers, or the like.

In some embodiments, FIG. 3A illustrates additional components including one or more centrifuges disposed within the housing 201 and configured to handle tubes and cartridges for sample processing. FIG. 3B illustrates a diagram of a top view of the analyzer device 200, according to embodiments of the present disclosure. FIG. 3B illustrates a cross-section of analyzer device 200 from a top view, showing the various components, modules, and/or subsystems arranged below the first and second pipettors 202, 204 within the housing 201 of the analyzer device 200.

The housing 201 in FIG. 3B includes the sample drawer 210 containing a plurality of sample tubes 212, sample cartridge drawer 220 containing a plurality of sample preparation cartridges 224, and processing cartridge drawer 230 containing both AST cartridges 232 and PCR cartridges 234. Sample tubes 212, sample preparation cartridges 224, and PCR cartridges 234 represent exemplary embodiments of sample tube 111, sample preparation cartridge 114, and PCR cartridge 117, shown in FIG. 1, respectively.

In some embodiments, processing cartridge drawer 230 may be configured to hold both AST cartridges 232 and PCR cartridges 234 for performing pathogen identification and antimicrobial susceptibility testing. In some embodiments, there may be a predefined number of sample tubes 212, sample preparation cartridges 224, AST cartridges 232, and/or PCR cartridges 234 held in their respective drawers in the housing 201 at a time. In some embodiments, the sample preparation cartridges 224, AST cartridges 232, and/or PCR cartridges 234 may be disposable after a single use or reusable for testing of additional samples.

FIG. 3B also illustrates first centrifuge 240, second centrifuge 242, PCR subsystem 244, homogenization subsystem 246, mechanical apparatus 248, and AST subsystem 250 arranged within housing 201.

In some embodiments, the first centrifuge 240 may be a high-speed centrifuge that is configured to centrifuge processing tubes (e.g., processing tubes 113) and/or spin column baskets that are placed in the first centrifuge 240 by the first pipettor 202. In some embodiments, the second centrifuge 242 may be a low-speed centrifuge that is configured to centrifuge PCR cartridges 234 that are placed in the second centrifuge 242 by the second pipettor 204. In some embodiments, the first and second centrifuges 240, 242 may centrifuge processing tubes, spin column baskets, and/or PCR cartridges 234 in a swing-bucket configuration. In some embodiments, the first and second centrifuges 240, 242 may comprise a cylindrical shape with a diameter of about 250 mm and a height of about 175 mm.

In some embodiments, the PCR subsystem 244 may comprise a thermal cycler equipped with an optical detection module or optical system to measure the fluorescence signal generated during each amplification cycle in the PCR cartridge 234 as one or more fluorophores bind to target sequences in the nucleic acid. In some embodiments, the thermal cycler may be configured to control temperatures when performing PCR (PCR), and the optical system may be configured to perform optical interrogation of primary and/or secondary reaction chambers in the PCR cartridge 234 by fluorescence.

In some embodiments, the thermal cycler of the PCR subsystem 244 may control temperatures in a range of about 35° C. to 100° C. In some embodiments, the optical system of the PCR subsystem 244 may perform fluorescence readings from the bottom of a PCR cartridge 234 in the housing 201 to detect signals from amplified nucleic acid products resulting from the PCR. In some embodiments, PCR cartridges 234 may be placed in the PCR subsystem 244 and removed from the PCR subsystem 244 by the second pipettor 204. In some embodiments, the PCR subsystem 244 may hold up to two PCR cartridges 234 at a time, in which the PCR cartridges 234 undergo thermal cycling independently in the PCR subsystem 244. In some embodiments, the dimensions of the PCR subsystem 244 may be about 70 mm (width)×125 mm (depth)×250 mm (height).

In some embodiments, homogenization subsystem 246 may be configured to hold a plurality of processing tubes in slots for applying a swinging movement to the processing tubes to allow oscillation or mixing of samples. In some embodiments, the first pipettor 202 may be configured to vertically load tubes into the slots in the homogenization subsystem 246. In some embodiments, the homogenization subsystem 246 may change the orientation of tubes from a vertical position to a horizontal position and apply a swinging movement of +15° around the horizontal position with a frequency of 1 Hz. In some embodiments, the homogenization subsystem 246 may hold up to about four 15 mL processing tubes at a time, in which each processing tube represents a different sample.

In some embodiments, the homogenization subsystem 246 may be equipped with a moveable magnet. The moveable magnet may engage the processing tubes when in vertical position in the homogenization subsystem 246. In some embodiments, the homogeny ization subsystem 246 may apply a 37° C. temperature control of processing tubes held in the homogenization subsystem 246. In some embodiments, the dimensions of the homogenization subsystem 246 may be about 150 mm (width)×175 mm (depth)×115 mm (height).

In some embodiments, mechanical apparatus 248 may be configured to agitate a processing tube to perform cell lysis of pathogens in samples. In some embodiments, the first pipettor 202 may be configured to vertically load tubes into slots in the mechanical apparatus 248. In some embodiments, the mechanical apparatus 248 may comprise an agitator device or a cell disrupting device that is configured to apply a fast vibration movement to a processing tube. In some embodiments, the mechanical apparatus 248 may apply the fast vibration movement by applying a reciprocating movement along a predetermined axis by the agitator while the processing tube is in a vertical position. In some embodiments, the mechanical apparatus 248 may hold up to two processing tubes at a time and apply a ±2° angular movement to the processing tubes. In some embodiments, the mechanical apparatus 248 may oscillate processing tubes at about 5,000-30,000 cycles/minute. In some embodiments, the dimensions of the mechanical apparatus 248 may be about 75 mm (width)×175 mm (depth)×100 mm (height). In additional or alternative embodiments, the mechanical apparatus 248 may comprise a sonicator that is configured to sonicate the processing tube to agitate the sample.

In some embodiments, AST subsystem 250 may comprise a heater configured for incubation of samples in an AST cartridge 232 in the housing 201 and an imaging subsystem for imaging reaction chambers of an AST cartridge 232. In some embodiments, the heater of the AST subsystem 250 may be used to control temperatures for incubation of samples in the AST cartridge 232. In some embodiments, pathogens may be concentrated and enriched in a sample and transferred to reaction wells in an AST cartridge 232 for imaging by the AST subsystem 250. In some embodiments, the imaging subsystem of the AST subsystem 250 may comprise a microscope configured to acquire images by scanning the bottom of each reaction chamber of the AST cartridge 232 using a motorized XYZ-translation stage. In some embodiments, the imaging subsystem of the AST subsystem 250 may include a fluorescent sensor, along with two optical channels for detecting different fluorescent signals (e.g., green and red).

In some embodiments, the AST subsystem 250 may identify an antimicrobial phenotypical resistance of the microorganisms (e.g., pathogens) based on the acquired images and/or signals. In some embodiments, AST cartridges 232 may be placed in the AST subsystem 250 and removed from the AST subsystem 250 by the second pipettor 204.

In some embodiments, the AST subsystem 250 may hold up to five AST cartridges 232 at a time. In some embodiments, the AST subsystem 250 may apply a temperature control for AST cartridges 232 held in the AST subsystem 250, such as by using a thermal block. In some embodiments, the AST subsystem 250 may apply about a 37° C. temperature control In some embodiments, the dimensions of the AST subsystem 250 may be about 200 mm (width)×185 mm (depth)×285 mm (height).

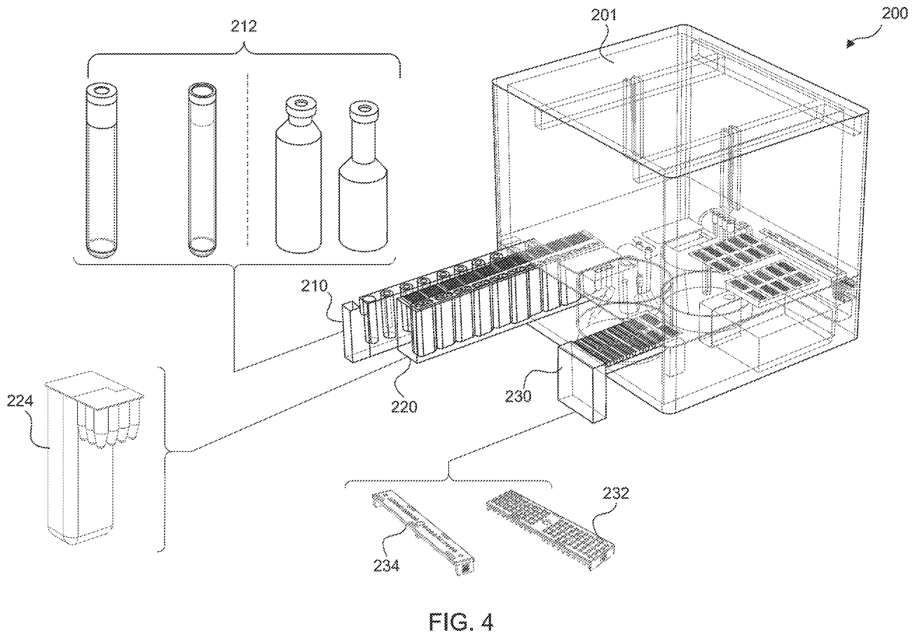

FIG. 4 illustrates a diagram of the analyzer device 200 with three opening compartments, according to embodiments of the present disclosure. In some embodiments, the analyzer device 200 in FIG. 4 shows the sample drawer 210, sample cartridge drawer 220, and processing cartridge drawer 230 extending out from the housing 201 in an open position for loading and/or unloading of samples and/or cartridges. The sample drawer 210, sample cartridge drawer 220, and processing cartridge drawer 230 may be pushed into the housing 201 in a closed position, in which the compartments fit into three corresponding receptacles in the housing 201. In some embodiments, the opening and closing of the sample drawer 210, sample cartridge drawer 220, and the processing cartridge drawer 230 may be controlled by a controller (e.g., controller 109) of the analyzer device 200 and/or by the processing device 116. In some embodiments, a user of the processing device 116 may control the opening and closing of the sample drawer 210, sample cartridge drawer 220, and the processing cartridge drawer 230 by using software installed on the processing device 116. In some embodiments, the sample drawer 210, sample cartridge drawer 220, and the processing cartridge drawer 230 may be manually pulled out and pushed into the housing 202 by a user to load and/or unload sample tubes, cartridges, and/or other elements into the analyzer device 200.

In some embodiments, the sample drawer 210 may hold multiple samples. In some embodiments, the sample drawer 210 may hold up to 10 samples at a time, including samples stored in sample tubes 212. In some embodiments, the sample tubes 212 shown in FIG. 4 may represent one or more blood sample tubes, urine sample tubes, and/or blood culture bottles. In some embodiments, the sample cartridge drawer 220 may hold multiple sample preparation cartridges, such as up to 10 sample preparation cartridges at a time. In some embodiments, the processing cartridge drawer 230 may hold multiple processing cartridges, such as up to 12 PCR cartridges, 6 AST cartridges, or a combination thereof, at a time.

In some embodiments, the dimensions of the sample drawer 210 may be about 40 mm (width)×155 mm (height)×600 mm (depth). In some embodiments, the dimensions of the sample cartridge drawer 220 may be about 85 mm (width)×155 mm (height)×615 mm (depth). In some embodiments, the dimensions of the processing cartridge drawer 230 may be about 140 mm (width)×155 mm (height)×270 mm (depth).

### Embodiments of Sample Processing, Concentration, Lysis, and Purification of Nucleic Acid in Analyzer Device

In some embodiments, pathogen identification includes transferring samples into consumables (e.g., processing tube 113 and/or a spin column) for further processing (e.g., nucleic acid extraction, purification and amplification) using a pipetting system, concentration of pathogens, lysis of pathogens (by mechanical disruption), purification of nucleic acid from pathogens, and amplification and identification of pathogens by PCR. In some embodiments, the first pipettor 202 of the analyzer device 200 may transfer a sample from the sample tube 111 into the processing tube 113 and perform steps to process, concentrate, separate and lyse pathogens in the sample and purify nucleic acids from the lysed pathogens before performing PCR.

In some embodiments, sample processing may include a step of blood cell lysis. In embodiments where the sample is a blood sample, the first pipettor 202 may be configured to perform blood cell lysis of the blood sample. The first pipettor 202 may add one or more lysis reagents to the processing tube 113. The one or more lysis reagents may be mixed with the blood sample in the processing tube 113 using a mixer (e.g., such as in homogenization subsystem 246) disposed in the housing 201 of the analyzer device 200 to lyse blood cells in the blood sample. In some embodiments, the one or more lysis reagents may include one or more saponin-based buffers. In some embodiments, the one or more lysis reagents may include one or more detergents, surfactants, or proteases.

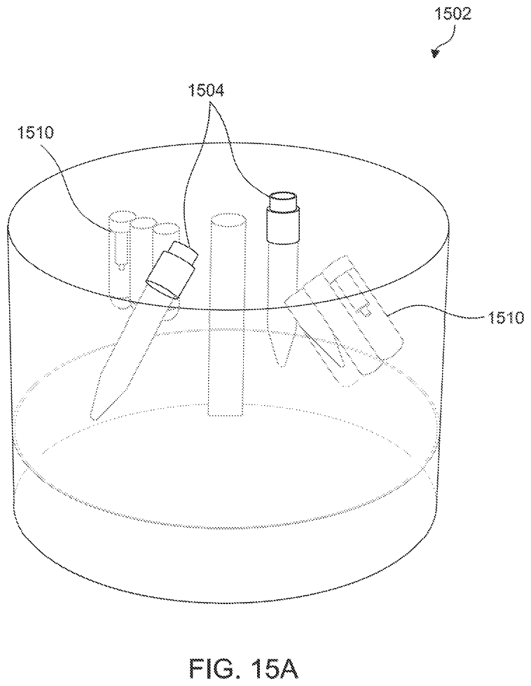

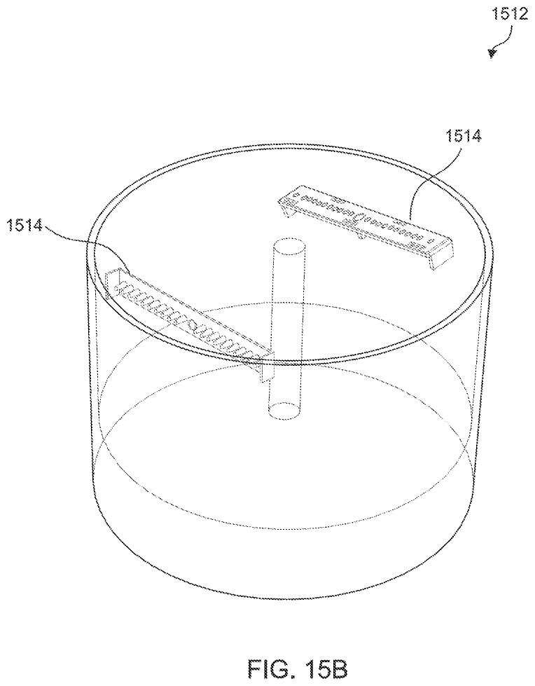

After lysis of the blood cells in the blood sample, the first pipettor 202 may transfer the processing tube 113 to the centrifuge 240 (or 1502 in FIG. 15A). In some embodiments, the centrifuge 240 may apply centrifugal force to the processing tube 113 to concentrate the pathogens in the sample. In some embodiments, the processing tube 113 may be centrifuged from a high volume (e.g., up to 10 mL) to a low volume (e.g., 2 mL or less) with the pathogens concentrated in the processing tube 113.

After centrifuging, the first or second pipettor 202, 204 may be used to remove a fluid from the processing tube 113, leaving the concentrated pathogens in the processing tube 113. In some embodiments, the first or second pipettor 202, 204 may add one or more lysis buffers to the concentrated pathogens in the processing tube 113. In some embodiments, the first or second pipettor 202, 204 may retrieve one or more lysis buffers from one or more reservoirs in the sample preparation cartridge and dispense the one or more lysis buffers to the processing tube 113 through a needle coupled to the first or second pipettor 202, 204. In some embodiments, a plurality of lysis beads may be added to the processing tube 113, along with the one or more lysis buffers, for performing lysis of the concentrated pathogens in the processing tube 113. In some embodiments, the plurality of lysis beads may be added to processing tube 113 of the sample preparation cartridge during manufacturing and/or assembly.

In some embodiments, the processing tube 113 may be agitated or sonicated in the analyzer device 200 to lyse the pathogens mechanically using the lysis beads and one or more lysis buffers. In some embodiments, the rapid movements of the lysis beads (resulting from agitation or sonication in the analyzer device 200) may mechanically disrupt cell walls of pathogens in the processing tube 113, resulting in a release of nucleic acids from the pathogens.

In some embodiments, following the pathogen lysis, the processing tube 113 may undergo an additional centrifuge step (by centrifuge 240) to drive liquid in the processing tube 113 to the bottom of the tube. In some embodiments, the first or second pipettor 202, 204 may remove a portion of the liquid from the processing tube 113, in which the portion of liquid includes the nucleic acids from the pathogens. In some embodiments, the cells, lysing beads, and debris resulting from the lysis is left behind in the processing tube 113.

After lysis and removal of the nucleic acids from the processing tube 113, the nucleic acids may be purified by using either a spin column or magnetic beads. In some embodiments, the first or second pipettor 202, 204 may transfer the portion of liquid from the processing tube 113 after the cell lysis to a spin column in the analyzer device 200. In some embodiments, the spin column may perform extraction and purification of the nucleic acid from the portion of liquid. In some embodiments, the eluate (e.g., purified nucleic acid) resulting from the spin column may be collected in a basket of the spin column.

In additional or alternative embodiments, the first or second pipettor 202, 204 may transfer the portion of liquid from the processing tube 113 after the cell lysis to one or more reservoirs in the sample preparation cartridge. In some embodiments, the one or more reservoirs may be configured to store magnetic beads for nucleic acid extraction and purification. In some embodiments, the magnetic beads may be configured to attach to the nucleic acid. In some embodiments, the analyzer device 200 may apply a magnetic force to retain the nucleic acids attached to the magnetic beads. In some embodiments, the first or second pipettor 202, 204 may then remove extraneous liquid from the nucleic acids attached to the magnetic beads while the nucleic acids attached to the magnetic beads are retained in the one or more reservoirs. The removal of the extraneous liquid may result in the one or more reservoirs containing the purified nucleic acid.

After purification, the nucleic acid obtained from the sample may subsequently be ready for transfer to the PCR cartridge 234 by the pipetting system in the analyzer 200 for performing nucleic acid amplification and identification of pathogens by PCR.

### Sample Preparation Cartridge Embodiments

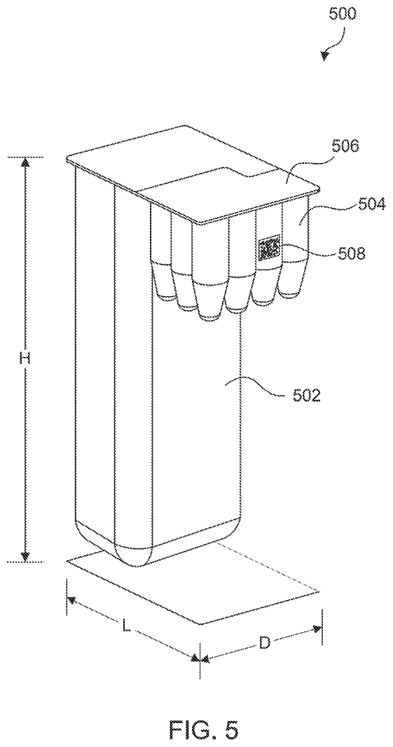

FIG. 5 illustrates a diagram of a sample preparation cartridge 500, according to embodiments of the present disclosure. Sample preparation cartridge 500 represents an exemplary embodiment of sample preparation cartridge 224 shown in FIG. 3B. The sample preparation cartridge 500 may be a consumable that is inserted into the sample drawer 210 of the analyzer device 200 for preparing and processing a sample in a sample tube. In some embodiments, the sample preparation cartridge 500 may be made by injection molding from a polypropylene (PP) material. The sample preparation cartridge 500 may comprise a housing 502, a plurality of reservoirs 504, a lid 506, and an identifier 508.

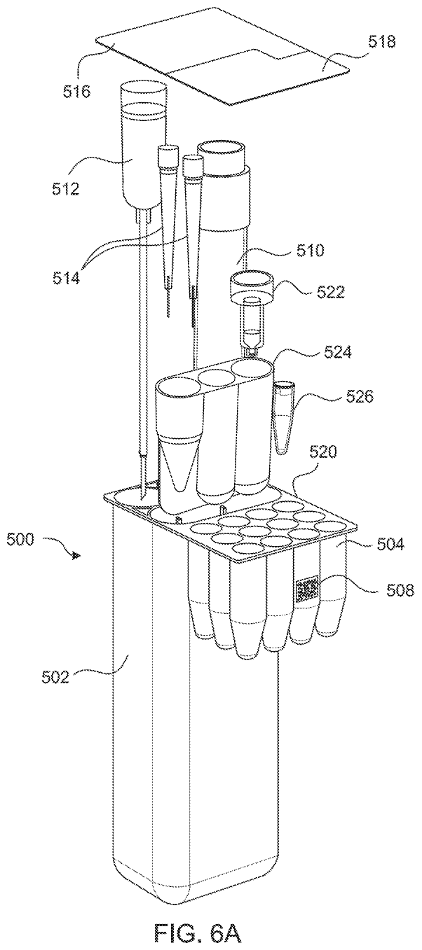

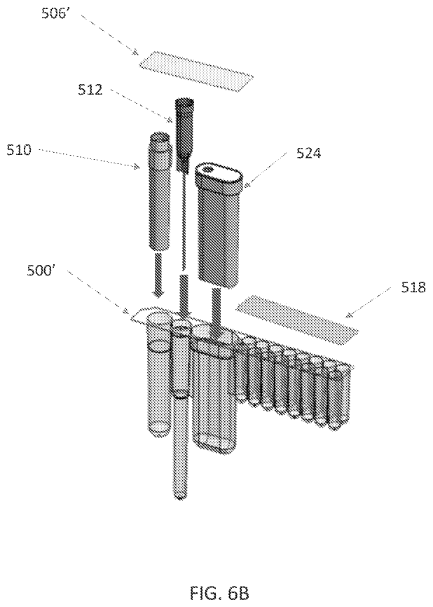

In some embodiments, the housing 502 may have an elongated rectangular shape with rounded edges. The housing 502 may be configured to hold additional elements used for sample preparation as shown in FIG. 6A. In some embodiments, the plurality of reservoirs 504 may be separate reservoirs or tubes molded together. The plurality of reservoirs 504 may be configured to store materials used for performing sample concentration, lysis, and/or nucleic acid amplification. In some embodiments, materials stored in the reservoirs 504 may include one or more buffers (e.g., NaCl-based buffers, phosphate-buffered saline (PBS, or the like), detergents, surfactants, proteases, growth media, or the like. In some embodiments, the reservoirs 504 may store one or more lysis reagents, such as one or more saponin-based buffers, detergents, surfactants, or proteases, for performing cell lysis of a blood sample. In some embodiments, the reservoirs 504 may store one or more wash materials, which may include a combination of one or more buffers, detergents, surfactants, and proteases.

In some embodiments, the lid 506 of the sample preparation cartridge 500 is a protective lid that extends across and covers the housing 502 and the plurality of reservoirs 504. In some embodiments, the identifier 508 is an identifier of the sample preparation cartridge 500 that may be scanned by the analyzer device 200 for performing pathogen identification. In some embodiments, the identifier 508 may be at least one of an identification code, barcode, or data matrix, such as a QR code. In some embodiments, the dimensions of the sample preparation cartridge 500 may be about 80 mm (width)×55 mm (depth)×155 mm (height) as shown in FIG. 5.

FIG. 6A illustrates an exploded-view diagram of the sample preparation cartridge 500 with a processing tube 510 and other components to be inserted therein, according to embodiments of the present disclosure. The sample preparation cartridge 500 may include processing tube 510, a first removable needle 512, two second removable needles 514, spin column 522, spin column basket 524, and reagent tube 526 that are stored in corresponding receptacles in the housing 502 of the sample preparation cartridge 500. Processing tube 510 represents an exemplary embodiment of processing tube 113 shown in FIG. 1.

In some embodiments, the processing tube 510 may comprise, for example, a 15 ml tube with a conical bottom. In some embodiments, the processing tube 510 may be removable from the sample preparation cartridge 500 for processing in other modules in the analyzer device 200. In some embodiments, the processing tube 510 may be the tube to which a sample is transferred after loading of a sample tube and the sample preparation cartridge 500 into the sample drawer 210 and sample cartridge drawer 220, respectively, of the analyzer device 200.

In some embodiments, the sample may be transferred by the first removable needle 512 from a sample tube in the sample drawer 210 to the processing tube 510 of the sample preparation cartridge 500 in the sample cartridge drawer 220. In some embodiments, the first pipettor 202 may attach to the first removable needle 512, which is configured to transfer the sample to and/or from the processing tube 510 by insertion of the first removable needle 512 through a septum of the processing tube 510. In some embodiments, the two second removable needles 514 may be used to handle low volumes, and the second pipettor 204 may be configured to attach to the two second removable needles 514.

FIG. 6A also illustrates the openings 520 of the plurality of reservoirs 504 of the sample preparation cartridge 500. In some embodiments, there may be 12 reservoirs 504 in the sample preparation cartridge 500, in which each reservoir 504 holds a volume of about 2.5 mL. In some embodiments, the sample preparation cartridge 500 may include a pierceable film 516 that covers the receptacles of the housing 502, and/or a foil seal 518 that covers the openings 520 of the plurality of reservoirs 504. In some embodiments, the pierceable film 516 may be a polyester film, and the foil seal 518 may comprise an aluminum foil, in which both the pierceable film 516 and the foil seal 518 are pierceable by the first and/or second removable needles 512, 514.

FIG. 6A further illustrates spin column 522, spin column basket 524, and reagent tube 526, which are stored in sample preparation cartridge 500. In some embodiments, the spin column 522 and the spin column basket 524 are used to perform nucleic acid extraction and purification of nucleic acid obtained from the sample. In some embodiments, reagent tube 526 stores one or more reagents used for performing nucleic acid amplification of the purified nucleic acid from the sample. In some embodiments, the reagent tube 526 may be sealed with an aluminum foil. In some embodiments, the spin column 522 may be configured for insertion and storage within the spin column basket 524. In some embodiments, the spin column basket 524 and reagent tube 526 are both configured to fit within corresponding receptacles in the sample preparation cartridge 500.

FIG. 6B illustrates an exploded-view diagram of a sample preparation cartridge 500′ with a processing tube 510 and other components to be inserted therein, according to embodiments of the present disclosure. Sample preparation cartridge 500′ is similar to sample preparation cartridge 500, but with a more linear form factor and a peelable film 506′ instead of lid 506.

### Processing Tube, Reagent Tube, Needle, and Spin Column Embodiments

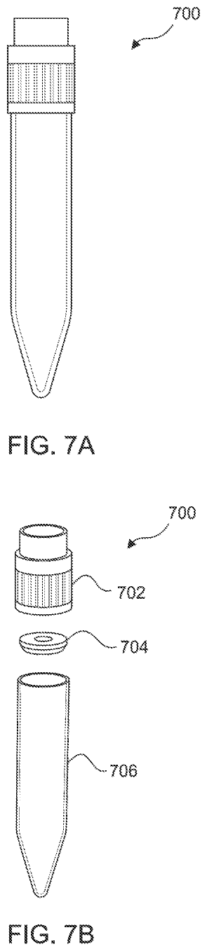

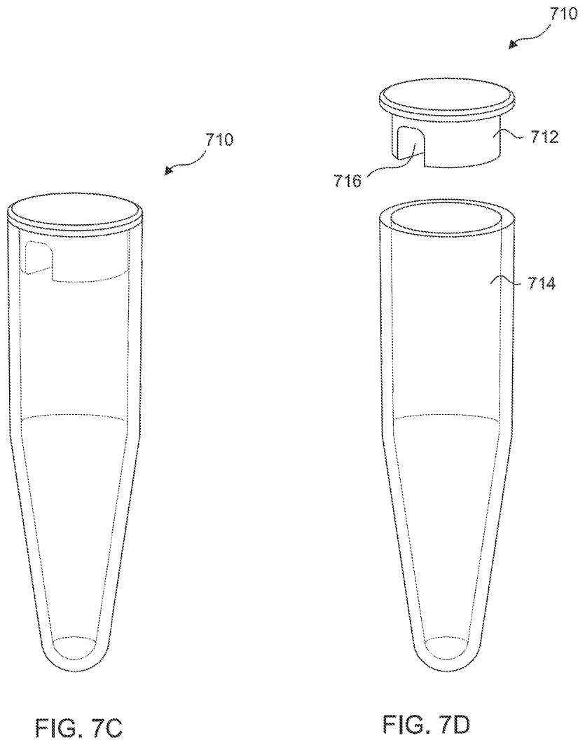

FIGS. 7A and 7B illustrate diagrams of a processing tube 700, according to embodiments of the present disclosure. Processing tube 700 represents an exemplary embodiment of processing tube 510 shown in FIG. 6A. In particular, FIG. 7A illustrates the processing tube 700 after assembly, whereas FIG. 7B illustrates an exploded view of the components in the processing tube 700. The processing tube 700 comprises a cap 702, a septum 704, and a tube 706.

In some embodiments, the septum 704 may be affixed inside the tube 706 with the cap 702 fitted over the septum 704 of the processing tube 700. In some embodiments, the septum 704 may be configured for insertion and removal of needles (e.g., needles 512 and 514) for transfer of liquids to and from the processing tube 700 without necessitating removal of the cap 702 from the tube 706. In some embodiments, the septum 704 may provide an airtight seal within the processing tube 700 and prevent contamination of the contents of the processing tube 700.

In some embodiments, the processing tube 700 may comprise a handling feature at a top end of the processing tube 700 that is compatible for handling by a pipettor (e.g., first and/or second pipettors 202, 204). In some embodiments, the handling feature of the processing tube 700 may be a cylindrical cavity in the cap 702 that is compatible for insertion by a tip of a pipettor. In some embodiments, the tip of a pipettor may be referred to herein as a mandrel. In some embodiments, the pipette tip of the first and second pipettors 202, 204 may press and fit into the cylindrical cavity in the cap 702 to pick up and move the processing tube around in the analyzer device 200.

In some embodiments, the cap 702 may be made of a high-density polyethylene (HDPE) material, and the tube 706 may be made from a polypropylene (PP) material. In some embodiments, the septum 704 may comprise at least one of a rubber, polytetrafluoroethylene (PTFE), thermoplastic elastomer (TPE), silicone, butyl rubber, or a combination thereof. In some embodiments, the septum 704 may comprise a double layer of polytetrafluoroethylene (PTFE) and another material selected from the group consisting of silicone, rubber, and butyl rubber. In some embodiments, the dimensions of the processing tube 700 after assembly may comprise a height of, for example, about 110 mm and a diameter of about 20 mm. In some embodiments, the septum 704 may have a thickness in a range of about 1 to 2 mm.

In some embodiments, the processing tube 700 may include a plurality of lysis beads disposed within the tube 706 and configured to perform lysis. In some embodiments, the plurality of lysis beads may be of a predetermined size and material configured to perform lysis of at least one of the following pathogens: yeast, fungi, gram-positive bacteria, gram-negative bacteria, or the like. In some embodiments, the processing tube 700 may be transferred to the mechanical apparatus 248 of the analyzer device 200, where fast vibrational movements may be applied to the plurality of lysis beads in order to perform lysis of pathogens in the sample in the processing tube 700. In some embodiments, the movements of the lysis beads may mechanically disrupt cell walls of pathogens in the sample, resulting in a release of nucleic acids from the pathogens.

In some embodiments, after cell lysis, the first or second pipettor 202 or 204 may transfer a portion of liquid from the processing tube 700 to one or more reservoirs 504 in the sample preparation cartridge 500, where a plurality of magnetic beads may be stored. In some embodiments, the plurality of magnetic beads in the one or more reservoirs 504 may be configured to attach to nucleic acids in the portion of liquid obtained from the processing tube 700. In some embodiments, the plurality of magnetic beads may be used to extract and purify the nucleic acids from the portion of liquid obtained from the processing tube 700.

FIGS. 7C and 7D illustrate diagrams of an example reagent tube 710, according to embodiments of the present disclosure. Reagent tube 710 represents an exemplary embodiment of reagent tube 526 shown in FIG. 6A. In some embodiments, reagent tube 710 may be referred to as a master mix tube. Reagent tube 710 may hold a first set of reagents used for performing nucleic acid amplification. In some embodiments, the first set of reagents may include one or more of DNA polymerase, deoxyribonucleotide triphosphate (dNTPs), magnesium chloride (MgCl₂), or the like. In some embodiments, the reagents stored in reagent tube 710 may be dried or freeze-dried. In some embodiments, reagent tube 710 may include a cap 712 and a tube 714. Cap 712 may include a septum, such as across the top of the cap. In some embodiments, the septum on cap 712 of the reagent tube 710 may be similar to the septum 704 of the processing tube 700. In some embodiments, the cap 712 may be configured to attach to the tube 714 to provide an airtight seal within the reagent tube 710 and prevent contamination of the contents of the reagent tube 710. In some embodiments, the cap 712 may include a recess 716 in order to facilitate the evacuation of air during a lyophilization process by a lyophilizer. In some embodiments, cap 712 may be slightly pressed into the tube 714 when inserted in a lyophilizer, such that there is air through the recess 716. The cap 712 may then be closed inside the lyophilizer by pressure of a lid, ensuring the air inside the tube 714 would be free of oxygen.

In some embodiments, the tube 714 may be made from a polypropylene (PP) material, and the septum on cap 712 may comprise at least one of a rubber, polytetrafluoroethylene (PTFE), thermoplastic elastomer (TPE), silicone, butyl rubber, or a combination thereof. In some embodiments, the septum may comprise a double layer of polytetrafluoroethylene (PTFE) and another material selected from the group consisting of silicone, rubber, and butyl rubber. In some embodiments, the dimensions of the reagent tube 710 after assembly (e.g., after attaching cap 712 to tube 714) may comprise a height of, for example, about 40 mm and a diameter of about 10 mm.

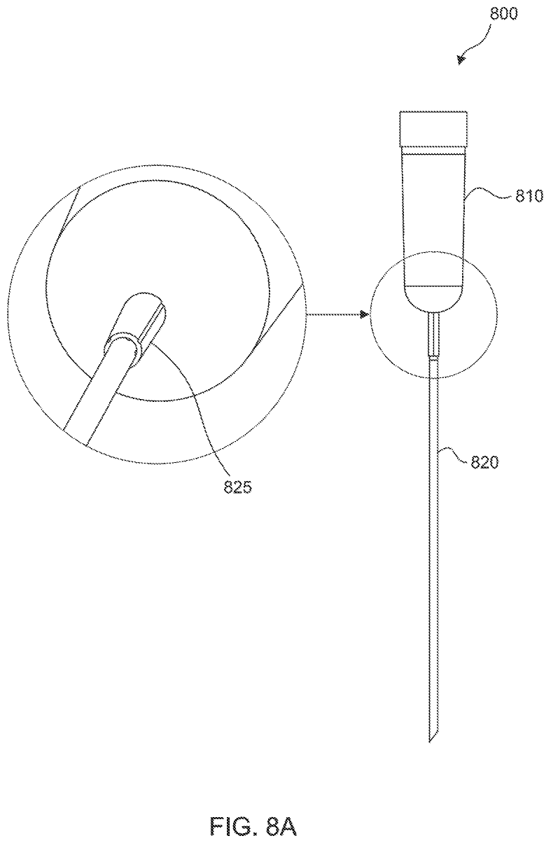

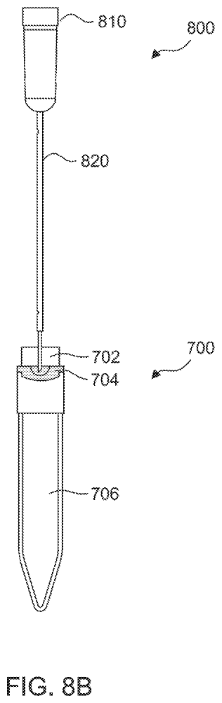

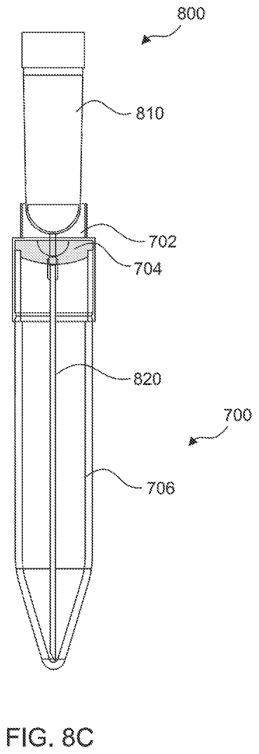

In some embodiments, the processing tube 700 and/or reagent tube 710 may be configured to receive needles as shown in FIGS. 8A, 8B, and 8C. FIGS. 8A, 8B, and 8C illustrate diagrams of a needle 800 configured for insertion into a processing tube 700 and/or reagent tube 710, according to some embodiments of the present disclosure. In particular, FIG. 8A illustrates needle 800 comprising a plastic body 810, a cannula 820, and a plurality of slots 825. In some embodiments, the plastic body 810 may be attached to the cannula 820 by bonding. In some embodiments, the pipettor(s) in the analyzer device (e.g., first pipettor 202) may attach to the proximal end of the plastic body 810 of the needle 800. In some embodiments, the plastic body 810 of the needle 800 includes an aerosol filter configured to prevent contamination of the pipettors in the analyzer device. In some embodiments, needle 800 may be a venting needle that is configured to vent the processing tube 700 upon insertion of the needle. In some embodiments, venting of the needle 800 may facilitate in relieving pressure in a sealed processing tube 700. In some embodiments, the plastic body 810 of the needle 800 comprises a predetermined number of slots 825 configured to provide an air connection between an inside and an outside of the processing tube 700 when the needle 800 is inserted through the septum 704 and into the tube 706. For example, there may be four slots 825 in the injected part of the needle 800 that holds the cannula 820. In some embodiments, the slots 825 may be generated by injection molding. In some embodiments, needle 800 may be inserted into the reagent tube 710 similarly to inserting the needle 800 into the processing tube 700. In some embodiments, the cannula 820 of needle 800 may be configured to pierce the septum for insertion into the tube 706 of the reagent tube 710.

FIG. 8B illustrates the needle 800 during insertion into the processing tube 700, and FIG. 8C illustrates the needle 800 after full insertion into the processing tube 700. In some embodiments, the cannula 820 of the needle 800 may be inserted into the cap 702, through the septum 704, and into the tube 706 of the processing tube 700. In some embodiments, the distal end of the plastic body 810 may fit into the cap 702 of the processing tube 700 upon full insertion of the cannula 820 into the tube 706.

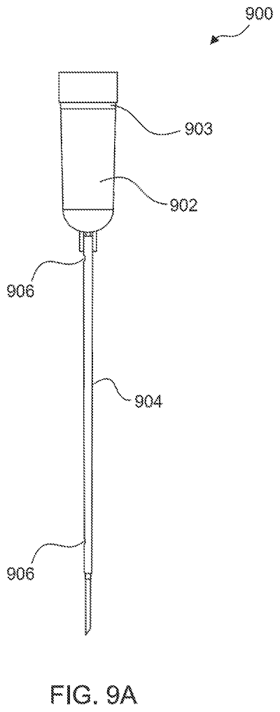

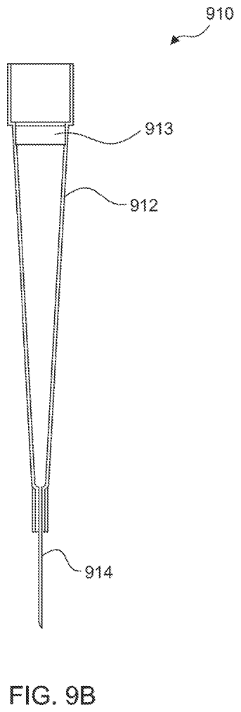

FIGS. 9A and 9B illustrate diagrams of a high volume needle 900 and a low volume needle 910, respectively, according to embodiments of the present disclosure. In some embodiments, high volume needle 900 and low volume needle 910 may be coupled to first pipettor 202 and second pipettor 204, respectively, in the analyzer device 200.

As shown in FIG. 9A, the high volume needle 900 may comprise a plastic body 902 and a cannula 904. In some embodiments, the plastic body 902 may be a reservoir configured to hold a volume of about 50 μL to 5 mL during liquid transfer in the analyzer device. In some embodiments, the plastic body 902 may include a filter 903 arranged within to prevent contamination of a pipettor coupled to the high volume needle 900.

In some embodiments, the plastic body 902 may be made of a polypropylene (PP) material. In some embodiments, the plastic body 902 of the needle 900 may have a diameter of about 16 mm and a length of about 50 mm. In some embodiments, the cannula 904 may be made of stainless steel. In some embodiments, the cannula 904 may have a length of about 100 mm. In some embodiments, the plastic body 902 and cannula 904 when assembled together may have a length of about 150 mm. In some embodiments, the high volume needle 900 may be a 17 gauge needle with an inner diameter (ID) of about 1.05 mm, an outer diameter (OD) of about 1.60 mm, and a cannula diameter (CD) of about 2.50 mm.

In some embodiments, the cannula 904 may further comprise a secondary cannula arranged around an inner core of the needle 900. In some embodiments, the cannula 904 comprises one or more venting holes 906. In some embodiments, the cannula 904 of the needle 900 may be in fluid communication with the venting hole 906. In some embodiments, the cannula 904 may be a slotted cannula with slots around the needle.

As shown in FIG. 9B, the low volume needle 910 may comprise a plastic body 912 and a needle shaft 914. In some embodiments, the plastic body 912 may be a reservoir configured to hold a volume of about 1 to 200 μL during liquid transfer in the analyzer device. In some embodiments, the plastic body 912 may include a filter 913 arranged within to prevent contamination of a pipettor coupled to the low volume needle 910. In some embodiments, the plastic body 912 may be made of a polypropylene (PP) material. In some embodiments, the plastic body 912 of the needle 910 may have a diameter of about 7.25 mm and a length of about 45 mm. In some embodiments, the needle shaft 914 may have a length of about 10 mm. In some embodiments, the needle shaft 914 may be made of stainless steel. In some embodiments, the low volume needle 910 may be a 29 gauge needle with an inner diameter (ID) of about 0.20 mm and an outer diameter (OD) of about 0.30 mm.

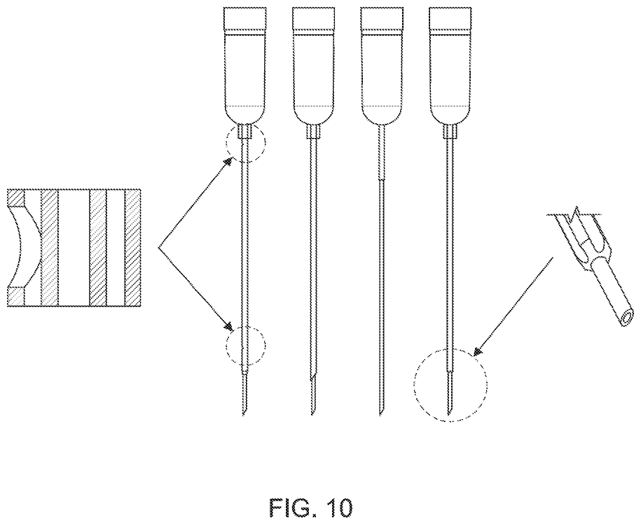

FIG. 10 illustrates a diagram of examples of the high volume needle 900, according to embodiments of the present disclosure. In particular, FIG. 10 illustrates various examples of the cannula of the high volume needle 900 with venting holes, slots, and the like. In some embodiments, the first needle shown in FIG. 10 may vent by having two connected orifices or venting holes in the cannula of the needle. In some embodiments, the second and fourth needles shown in FIG. 10 may vent when the tip of each needle is inserted into the septum (e.g. septum 704) of the processing tube.

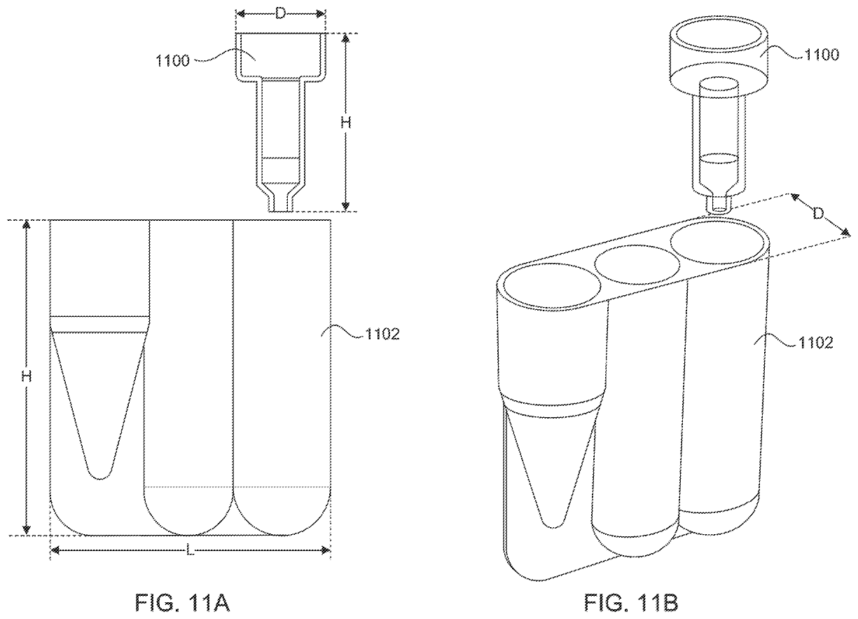

FIGS. 11A and 11B illustrate diagrams of a spin column 1100 and spin column basket 1102, according to embodiments of the present disclosure. Spin column 1100 and spin column basket 1102 represent exemplary embodiments of spin column 522 and spin column basket 524 shown in FIG. 6A, respectively. In particular, the spin column 1100 may be configured to perform nucleic acid extraction and purification of nucleic acid obtained from a sample. In some embodiments, after performing cell lysis in the processing tube 700, the first pipettor 202 or second pipettor 204 may transfer a portion of liquid from the processing tube 700 to the spin column 1100. In some embodiments, the spin column 1100 may be configured to extract and purify a nucleic acid from the portion of liquid. In some embodiments, the spin column 1100 may be configured to move to an elution position in the spin column basket 1102 to obtain a nucleic acid from a sample. In some embodiments, the spin column basket 1102 may be configured to collect the purified nucleic acid that passes through the spin column 1100. In some embodiments, the spin column basket 1102 may include one or more tubular receptacles that are configured to receive the purified nucleic acid, store the spin column 1100, and/or receive a needle coupled to the first or second pipettor 202, 204.

In some embodiments, the spin column 1100 may have a height H of about 34 mm. In some embodiments, an upper portion of the spin column 1100 may have a diameter D of about 17 mm. In some embodiments, the spin column basket 1102 may have a length L of about 50 mm and a height H of about 60 mm. In some embodiments, the diameter of the tubular receptacles in the spin column basket 1102 may be about 19 mm. In some embodiments, the spin column 1100 and the spin column basket 1102 may be made of a polypropylene (PP) material.

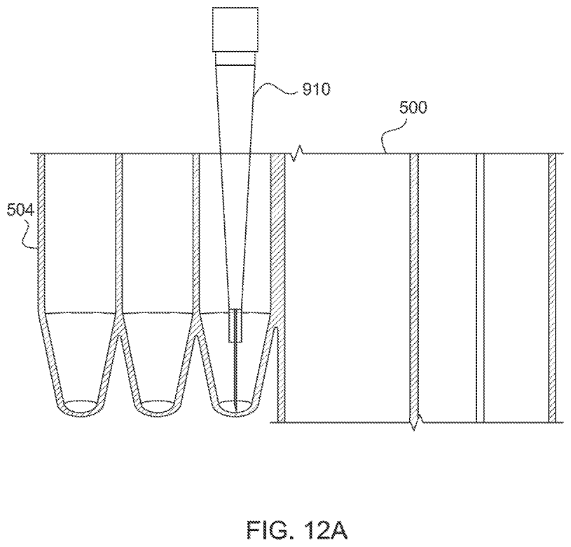

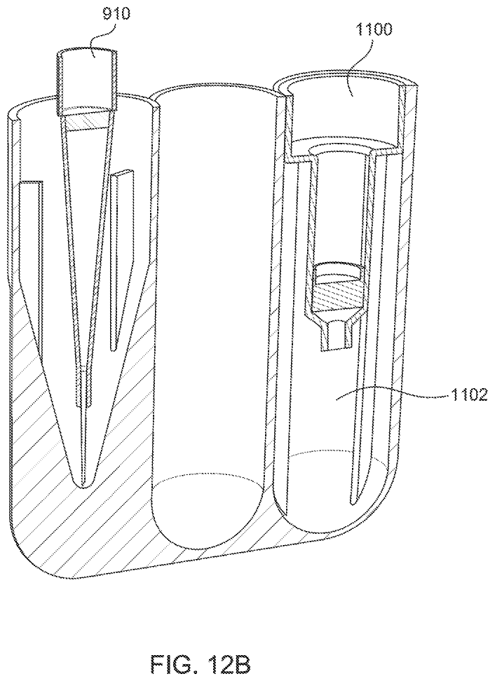

FIG. 12A illustrates a diagram of the low volume needle 910 interfacing with the sample preparation cartridge 500, according to embodiments of the present disclosure. In particular, FIG. 12 shows an example of the low volume needle 910 disposed in one of the plurality of reservoirs 504 of the sample preparation cartridge 500, such as for transferring materials used for sample concentration and/or lysis from the reservoirs 504 to a sample in the processing tube. In some embodiments, the sample preparation cartridge 500 may be configured to receive one needle, such as low volume needle 910. In other embodiments, the sample preparation cartridge 500 may be configured to receive two needles, such as both high volume needle 900 and low volume needle 910.

FIG. 12B illustrates a low volume needle 910 interfacing with a spin column basket 1102, according to embodiments of the present disclosure. In some embodiments, the low volume needle 910 may be inserted into one of the tubular receptacles of the spin column basket 1102. In some embodiments, the spin column 1100 may also be disposed within one of the tubular receptacles of the spin column basket 1102.

### PCR Cartridge Embodiments

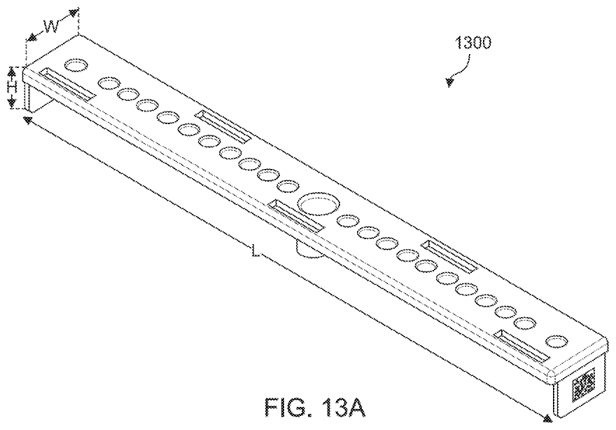

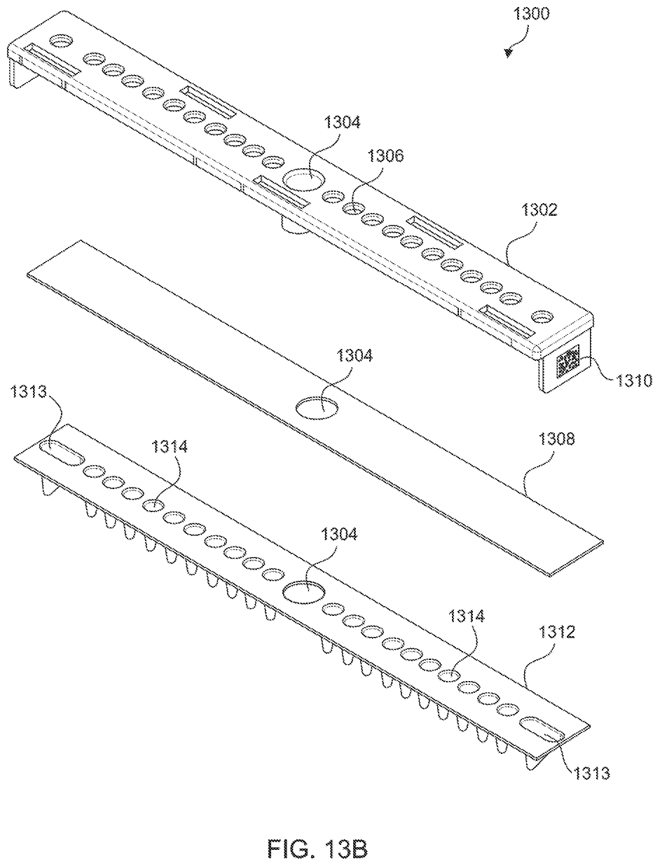

FIGS. 13A and 13B illustrate diagrams of an PCR cartridge 1300, according to embodiments of the present disclosure. PCR cartridge 1300 represents an exemplary embodiment of PCR cartridge 234. In particular, FIG. 13A illustrates the PCR cartridge 1300 after assembly, whereas FIG. 13B illustrates an exploded view of the components in the PCR cartridge 1300. The PCR cartridge 1300 comprises a cover 1302, a septum 1308, and a base 1312. In some embodiments, the cover 1302 is arranged over the septum 1308, and the septum is arranged over the base 1312.

In some embodiments, the base 1312 comprises two primary reaction chambers 1313 and a plurality of secondary reaction chambers 1314. In some embodiments, there may be at least one primary reaction chamber 1313 in the base 1312. In some embodiments, the number of secondary reaction chambers 1313 in the base 1312 may be in a range of about 10 to 50, for example, 20 secondary reaction chambers. In some embodiments, each primary reaction chamber 1313 may hold a volume in a range of about 50 to 500 μL, for example, 100 μL. In some embodiments, each secondary reaction chamber 1314 may hold a volume in a range of about 2 to 50 μL, for example, 30 μL. In some embodiments, each primary reaction chamber 1313 and the plurality of secondary reaction chambers 1314 may be sealed with a septum 1308, in which the septum 1308 is configured to receive a needle (e.g., needle 900 or 910).

In some embodiments, the PCR cartridge 1300 may include an additional receptacle configured to receive the reagent tube 710 storing the first set of reagents used for performing nucleic acid amplification. In other embodiments, the first set of reagents used for performing nucleic acid amplification may be stored within a reservoir in the PCR cartridge 1300, such as in one of the reaction chambers in the PCR cartridge 1300. For example, one of the primary reaction chambers 1313 of the PCR cartridge 1300 may store the first set of reagents used for performing nucleic acid amplification (e.g., a master mix). In some embodiments, the needle 900 or 910 may dispense one or more reagents from the first set of reagents (e.g., stored in one of the primary reaction chambers 1313 in the PCR cartridge 1300 or stored in reagent tube 710) to one of the primary reaction chambers 1313 for performing nucleic acid amplification.

In some embodiments, at least one primary reaction chamber 1313 may be configured to receive nucleic acid from the sample (e.g., after concentration, lysis, and purification steps), which may be transferred from the processing tube 700 by needle 900 or 910 coupled to the first pipettor 202 or the second pipettor 204, after resuspending the master mix. In some embodiments, the primary reaction chamber 1313 may be configured to perform a first amplification of the nucleic acid, resulting in a first amplified product.

In some embodiments, a set of primers are present in the primary reaction chamber 1313. In some embodiments, a set of dried primers are present in the primary reaction chamber 1313. In some embodiments, a set of primers may be transferred to the primary reaction chamber 1313 along with the nucleic acid for the first amplification. In some embodiments, the set of primers may be compatible with an amplification of target sequences to be detected. In some embodiments, different sets of primers may be transferred to the primary reaction chamber 1313 along with the nucleic acid for the first amplification. In some embodiments, a combination of the different sets of primers may be compatible with an amplification of target sequences to be detected.

In some embodiments, the secondary reaction chambers 1314 may be configured to receive a respective aliquot of the first amplified product from the primary reaction chamber 1313 by the needle 900 or 910. In some embodiments, the plurality of secondary reaction chambers 1314 may be configured to perform a second amplification of the product nucleic acid. In some embodiments, the aliquot of the first amplified product from the primary reaction chamber 1313 may be diluted with the contents of one of the reservoirs 504 of sample preparation cartridge 500.

In some embodiments, each secondary reaction chamber 1314 may include a set of reagents for reacting with the respective aliquot of the first amplified product. In some embodiments, the reagents disposed within each secondary reaction chamber 1314 may be in a liquid form, or in a dried or freeze dried form at a bottom of each secondary reaction chamber 1314. In some embodiments, the reagents disposed within each secondary reaction chamber 1314 may be added to each secondary reaction chamber 1314 in the base 1312 by the first or second pipettor 202, 204 prior to the dispensing the plurality of aliquots of the first amplified product to the secondary reaction chambers 1314. In some embodiments, the set of reagents in each secondary reaction chamber 1314 may correspond to inner sequences of amplicons in the first amplified product and may be specific to one or more target sequences to be detected. In some embodiments, the set of reagents in each secondary reaction chamber 1314 may comprise fluorescent probes that are specific to one or more target sequences to be detected.

In some embodiments, the first or second pipettor 202, 204 in the analyzer device 200 may dispense a nucleic acid from a sample to the primary reaction chambers 1313 in the PCR cartridge 1300 after concentration of pathogens, lysis of pathogens to release nucleic acid, and purification of the nucleic acids in the processing tube 700. After the first amplification of the nucleic acid in the primary reaction chambers 1313, the first or second pipettor 202, 204 in the analyzer device 200 may then dispense a plurality of aliquots of a first amplified product to the secondary reaction chambers 1314, in which each aliquot corresponds to a respective secondary reaction chamber 1314. In some embodiments, the first amplified product may be referred to as a pre-amplified product.

In some embodiments, each secondary reaction chamber 1314 may be configured to receive the aliquot of the first amplified product by a contactless dispensing of the aliquot by a needle (e.g., needle 900 or 910 coupled to the first or second pipettor 202, 204). In some embodiments, the needle may penetrate the septum 1308 of each secondary reaction chamber 1314 to dispense each aliquot without the needle contacting the bottom surface of each secondary reaction chamber 1314. In some embodiments, a volume of each aliquot dispensed by the needle 900 or 910 to each secondary reaction chamber 1314 may be in a range of about 0.5 μL to about 5 μL. In some embodiments, the first or second pipettor 202 or 204 may add, to the first amplified product, a preliminary set of reagents used for nucleic acid amplification in a reagent tube (e.g., reagent tube 710) prior to the dispensing of the plurality of aliquots of the first amplified product to the secondary reaction chambers 1314 in the PCR cartridge 1300.

In some embodiments, at least one primary reaction chamber 1313 and the plurality of secondary reaction chambers 1314 may comprise mineral oil to prevent at least one of evaporation, aerosol formation, and cross-contamination. In some embodiments, each secondary reaction chamber 1314 may be configured to receive the mineral oil before receiving the respective aliquot of the first amplified product from the needle 900 or 910. In some embodiments, the mineral oil in each secondary reaction chamber 1314 may be stored separately from the set of reagents in each secondary reaction chamber 1314. In some embodiments, the at least one primary reaction chamber 1313 and the plurality of secondary reaction chambers 1314 may receive an additional set of reagents that are used for nucleic acid amplification (e.g., in addition to the reagents stored in secondary reaction chamber 1314). In some embodiments, the additional set of reagents may be dried or freeze-dried and stored in a reagent tube, such as reagent tube 710.

In some embodiments, each primary and secondary reaction chamber 1313, 1314 comprises a conical shape and a bottom wall. In some embodiments, each primary reaction chamber 1313 may have a larger width than the individual width of each secondary reaction chamber 1314. In some embodiments, a diameter of the bottom wall of each of the at least one primary reaction chamber 1313 and the plurality of secondary reaction chambers 1314 may be less than about 2.5 mm. In some embodiments, the contactless dispensing of the plurality of aliquots to each secondary reaction chamber 1314 may include using jet dispensing in order to avoid reaction chamber cross-contamination of the aliquots by needle 900 or 910 in the sample preparation cartridge 500 penetrating respective septums of the secondary reaction chambers 1314 and without the needle 900 or 910 contacting a bottom wall of each secondary reaction chamber 1314.

In some embodiments, the bottom wall of each primary and secondary reaction chamber 1313, 1314 may be optically transparent and configured for optical interrogation. In some embodiments, the bottom wall of each primary and secondary reaction chamber 1313, 1314 may be configured for optical interrogation, such as by PCR subsystem 244 in analyzer device 200. In some embodiments, the bottom wall of each primary and secondary reaction chamber 1313, 1314 may be configured for fluorescence detection, such as by PCR subsystem 244 in analyzer device 200. In some embodiments, the plurality of primary and secondary reaction chambers 1313, 1314 may be configured to fit into corresponding chambers in a temperature control block in the PCR subsystem 244, and the temperature control block may be configured to heat the sides of the plurality of primary and secondary reaction chambers 1313, 1314.

The septum 1308 seals each primary reaction chamber 1313 and each secondary reaction chamber 1314 of the base 1312. In some embodiments, the septum 1308 may be referred to as a sealing cap mat. In some embodiments, the septum 1308 may comprise a unibody that extends across the primary reaction chambers 1313 and the plurality of secondary reaction chambers 1314 of the base 1312. In some embodiment, the septum 1308 may comprise multiple parts assembled together, wherein each part covers one or more respective primary and secondary reaction chambers 1313, 1314 of the base 1312. The septum 1308 may be configured to receive a needle, such as needle 900 or 910 coupled to the first or second pipettor 202, 204. In some embodiments, the needle may create orifices in the septum 1308 during insertion, and the orifices in the septum 1308 may close up when the needle is removed as a result of the material of the septum 1308.

In some embodiments, the septum 1308 may comprise at least one of a rubber, polytetrafluoroethylene (PTFE), thermoplastic elastomer (TPE), silicone, butyl rubber, or a combination thereof. In some embodiments, the septum 1308 may comprise a double layer of polytetrafluoroethylene (PTFE) and another material selected from the group consisting of silicone, rubber, and butyl rubber. In some embodiments, the septum 1308 may have a thickness in a range of about 1 to 2 mm. In some embodiments, the septum 1308 may be designed in such a way that optical interrogation (e.g., fluorescence) may be conducted by PCR subsystem 244 from above.

In some embodiments, the cover 1302 may comprise a plurality of openings 1306, wherein each opening 1306 aligns with a respective primary or secondary reaction chamber 1313, 1314 of the plurality of primary and secondary reaction chambers 1313, 1314 in the base 1312. In some embodiments, the cover 1302 may also include an identifier 1310. The identifier 1310 may be an identifier of the PCR cartridge 1300 that is scanned by the analyzer device 200 for performing pathogen identification. In some embodiments, the identifier 1310 may be at least one of an identification code, barcode, or data matrix.

In some embodiments, the cover 1302 may fit over the septum 1308 and base 1312 to form an assembled PCR cartridge 1300. In some embodiments, the septum 1308 may be overmolded into the cover 1302 to form a combined component, and the combined component may be assembled over the base 1312 by at least one of a snap-fit joint or a mechanical fastener. In some embodiments, the cover 1302, septum 1308, and base 1312 may be interlocked or clamped together by one or more mechanical fasteners.

In some embodiments, the base 1312, the septum 1308, and the cover 1302 each comprise an opening 1304 in a center of the PCR cartridge 1300. Opening 1304 may be sized or shaped so as to engage with an object handler within the system. For example, in some embodiments, the opening 1304 may be a circular hole that is compatible for insertion by a pipette tip holder (e.g., first and second pipettors 202, 204) for moving the PCR cartridge 1300 in the analyzer device 200. In some embodiments, the opening 1304 in the base 1312, the septum 1308, and the cover 1302 may align with each other upon assembly of the PCR cartridge 1300. In some embodiments, the base 1312 and cover 1302 may be made of a polypropylene (PP) or a polycarbonate (PC) material. In some embodiments, the dimensions of the assembled PCR cartridge 1300 may be about 135 mm (length)×15 mm (width)×10 mm (height).

In some embodiments, the assembled PCR cartridge 1300 may be configured to receive a heating lid that is disposed over the cover 1302 and over the primary and secondary reaction chambers 1313, 1314, during PCR performed within the PCR subsystem 244. In some embodiments, the heating lid may be configured to heat upper portions of the at least one primary reaction chamber 1313 and the plurality of secondary reaction chambers 1314 to prevent condensation during thermal cycling.

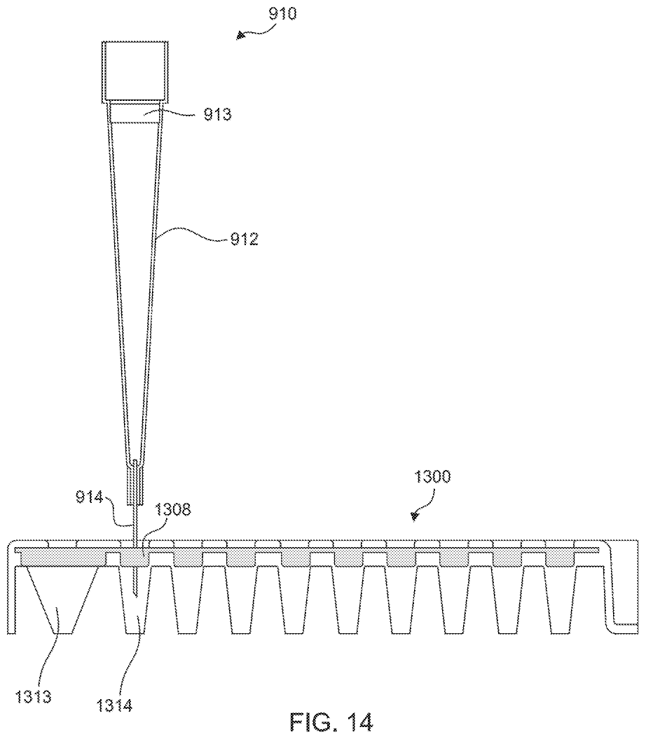

FIG. 14 illustrates a diagram of the low volume needle 910 being inserted into the PCR cartridge 1300, according to embodiments of the present disclosure. In particular, FIG. 14 shows the needle shaft 914 of the needle 910 piercing through the septum 1308 and into the secondary reaction chamber 1314 of the PCR cartridge 1300. In some embodiments, the needle shaft 914 may create orifices in the septum 1308 during insertion. The orifices in the septum 1308 may close up when the needle shaft 914 is removed as a result of the material of the septum 1308.

### Embodiments of PCR Methods in the PCR Cartridge

In diagnostic applications when there are both high sensitivity requirements (due to low copy number available in the original sample) and a large number of microorganisms of interest, two-stage PCR may offer an attractive combination to meet both extremes. Nevertheless, two-stage PCR approaches might not be used often due to the need to retrieve the amplified product after a first amplification step (pre-amplification) and deliver the amplified product to secondary containers for further amplification. In some embodiments, the use of an amplified product may involve risks of contaminations for test equipment, and also for laboratory facilities, which may result in extensive cleaning or even in a shutdown of laboratory facilities.

In some embodiments, the PCR cartridge 1300 includes primary and secondary reaction chambers 1313 and 1314 sealed by a septum 1308, which may allow the transfer of pre-amplified liquid volumes to subsequent PCR reactions while minimizing contamination risks without the need to work with open tubes. In some embodiments, the configuration of the PCR cartridge 1300 may be compatible with real-time PCR, with the fluorescence readings being performed by the PCR subsystem 244 from below the reaction chambers 1313, 1314. In some embodiments, the septum lid 1308 may be designed in a way such that fluorescence optical interrogation can be conducted from above.

In some embodiments, reagents for secondary reactions in the secondary reaction chambers 1314 may be dried down at the bottom of the secondary reaction chambers 1314. In some embodiments, jet dispensing may be used to deliver the pre-amplified product to secondary reaction chambers 1314 (e.g., with volumes in the range of 5 μL or below). In some embodiments, jet dispensing methods may prevent contact dispensing, which may involve cross-contamination issues. and spin steps that may slow down the overall process.

In some embodiments, an assay strategy for PCR may include a (1) first stage PCR primer set to increase a copy number of pathogens of interest, (2) a dilution step from the first stage to second stage, and (3) a second stage PCR conducted by multiple reaction chambers, such as in Taqman based assays to provide further specificity and semi-quantification information.

In some embodiments, a method to perform a contamination-free two-stage PCR may include: (1) delivering a template to at least one primary reaction chamber 1313 in the PCR cartridge 1300 through a septum 1308, in which the template includes a set of reagents used for nucleic acid amplification; (2) performing a first amplification step within the at least one primary reaction chamber 1313; (3) removing the first amplified product from the at least one primary reaction chamber 1313 through the septum 1308; (4) performing a contactless dispensing of respective aliquots of the first amplified product to a plurality of secondary reaction chambers 1314 through the septum 1308, in which each secondary reaction chamber 1314 includes reagents for performing a specific reaction from the plurality of secondary reaction chambers 1314.

### Embodiments of Modules and Subsystems in the Analyzer

FIGS. 15A and 15B illustrate diagrams of example centrifuges used in the analyzer device 200, according to embodiments of the present disclosure. In particular, FIG. 15A illustrates a first centrifuge 1502 that may be used to centrifuge samples in a processing tube 1504 or spin column baskets 1510, whereas FIG. 15B illustrates a second centrifuge 1512 that can be used to centrifuge samples in a PCR cartridge 1514. First and second centrifuges 1502, 1512 represent exemplary embodiments of first and second centrifuges 240, 242 shown in FIG. 3B, respectively. Processing tube 1504 and PCR cartridge 1514 represent exemplary embodiments of processing tube 700 and PCR cartridge 1300, shown in FIGS. 7A-7B and FIGS. 13A-13B, respectively. In some embodiments, spin column baskets 1510 may include spin columns stored within receptacles therein. Spin column baskets 1510 represent exemplary embodiments of spin column basket 1102 shown in FIGS. 11A, 11B, and 12B.

In some embodiments, the first centrifuge 1502 may be a high-speed centrifuge that is configured to apply a relative centrifugal force (RCF) or g force of about 12,000 G to the processing tube 1504 and/or spin column basket 1510. In some embodiments, the second centrifuge 1512 may be a low-speed centrifuge that is configured to apply a relative centrifugal force (RCF) or g force of about 3,000 G to PCR cartridge 1514.

In some embodiments, the first centrifuge 1502 may hold the processing tube 1504 and/or spin column basket 1510 in a first orientation and apply a 45° swing-bucket centrifugation to the processing tube 1504 and/or spin column basket 1510. In some embodiments, the second centrifuge 1512 may hold the PCR cartridge 1514 in another orientation and apply a 90° swing-bucket centrifugation, such that the PCR cartridge 1514 moves to a vertical position in the second centrifuge 1512.

In some embodiments, the first centrifuge 1502 and the second centrifuge 1512 may centrifuge multiple processing tubes 1504, spin column baskets 1510, and PCR cartridges 1514, respectively, at a time. For example, the first centrifuge 1502 may be configured to hold two processing tubes 1504 and two spin column baskets 1510 at a time for centrifuging together. In another example, the second centrifuge 1512 may be configured to hold two PCR cartridges 1514 at a time for centrifuging together. In some embodiments, processing tubes 1504 may be moved into the first centrifuge 1502 during the concentration and lysis steps for isolating a nucleic acid from a sample with pathogens.

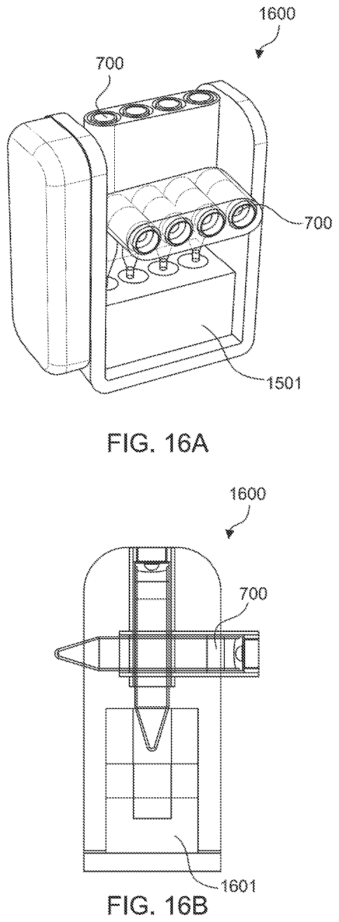

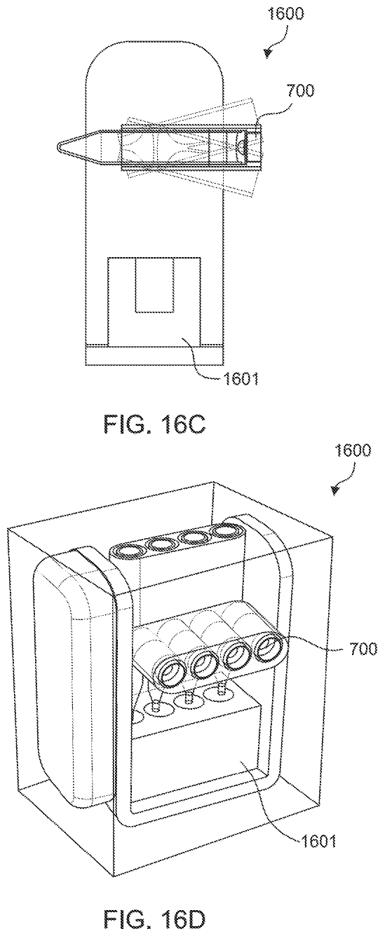

FIGS. 16A, 16B, 16C, and 16D illustrate diagrams of an example homogenization subsystem 1600 used in the analyzer device 200, according to embodiments of the present disclosure. Homogenization subsystem 1600 represents an exemplary embodiment of homogenization subsystem 246 shown in FIG. 3B. In some embodiments, homogenization subsystem 1600 may apply a swinging motion to processing tubes 700 to allow oscillation and mixing of the samples with other materials. In some embodiments, the processing tube 700 may be placed in the homogenization subsystem 1600 by the pipetting system (e.g., first or second pipettor 202, 204) for mixing of the pathogens in processing tube 700 with any reagents, such as for performing blood cell lysis. In some embodiments, the processing tube 700 may be placed in the homogenization subsystem 1600 for mixing of one or more lysis reagents or buffers with a blood sample in the processing tube 700 to lyse blood cells in the blood sample. In some embodiments, the mixing functionality of the homogenization subsystem 1600 may be used for sample processing for both pathogen identification and/or antimicrobial susceptibility testing in the analyzer device 200.

In some embodiments, the homogenization subsystem 1600 may be a mixer, such that it rotates one or more processing tubes 700 in a horizontal position by swinging the processing tubes 700 back and forth at a ±30° angle. In some embodiments, four processing tubes 700 may be loaded into the homogenization subsystem 1600 at a time. In some embodiments, the homogenization subsystem 1600 may include a magnet 1601 that moves back and forth between an up position and a down position. In some embodiments, one or more processing tubes 700 may include magnetic beads that are configured to attach to nucleic acids in the one or more processing tubes 700. In some embodiments, the magnet 1601 may be used to retain the nucleic acids attached to the magnetic beads in the one or more processing tubes 700.

In some embodiments, the homogenization subsystem 1600 may include an additional or alternative independent magnet station that may be used to retain nucleic acids attached to magnetic beads in the processing tube 700 and/or in the PCR cartridge 1300. In some embodiments, the magnet station in the homogenization subsystem 1600 may be used to move nucleic acids attached to magnetic beads to the bottom or side of the processing tube 700, such that the remainder of liquid in the processing tube may be removed and the nucleic acids retained.

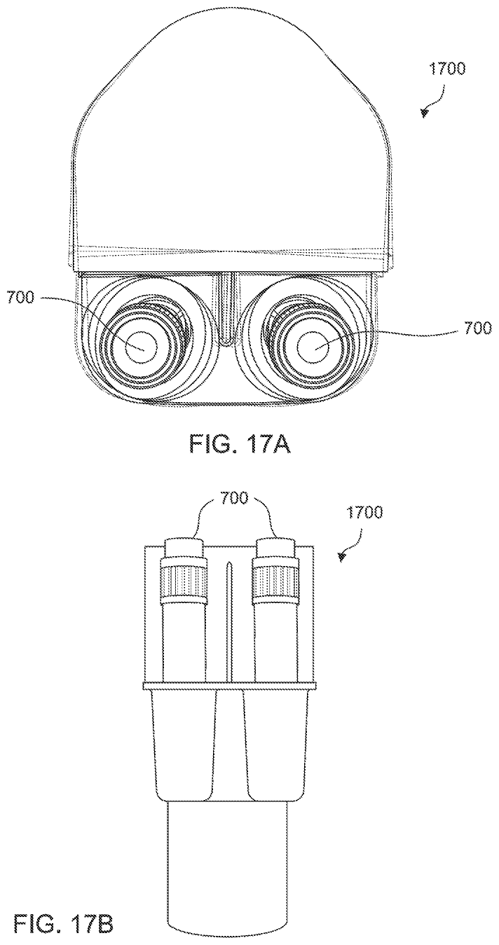

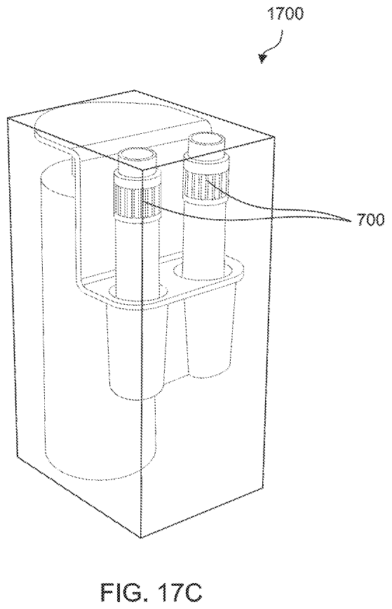

FIGS. 17A, 17B, and 17C illustrate diagrams of an example mechanical apparatus 1700 used in the analyzer device 200, according to embodiments of the present disclosure. Mechanical apparatus 1700 represents an exemplary embodiment of mechanical apparatus 248 shown in FIG. 3B. In some embodiments, mechanical apparatus 1700 may hold two processing tubes 700 in a vertical position and provide fast vibrational movements to the processing tubes 700, such as for performing lysis of microorganisms in samples. In some embodiments, mechanical apparatus 1700 may be an agitator. In additional or alternative embodiments, the mechanical apparatus 1700 may include a sonicator that is configured to sonicate the processing tube 700 to agitate the sample.

In some embodiments, there may be a plurality of lysis beads disposed within each processing tube 700 for performing lysis. In some embodiments, the plurality of lysis beads may be of a predetermined size and material configured to perform lysis of at least one of the following pathogens: yeast, fungi, gram-positive bacteria, gram-negative bacteria, or the like. In some embodiments, the plurality of lysis beads may be a mix of a plurality of predetermined sizes and materials configured to perform lysis of diverse pathogens types, including yeast, fungi, gram-positive bacteria, gram-negative bacteria, or the like. In some embodiments, the fast vibrational movements applied to the processing tube 700 may excite the plurality of lysis beads in the processing tube 700, such that the lysis beads perform lysis of pathogens in the sample in the processing tube 700. In some embodiments, the rapid movements of the lysis beads (applied by the mechanical apparatus 1700) may mechanically disrupt cell walls of pathogens in the sample, resulting in a release of nucleic acids from the pathogens.

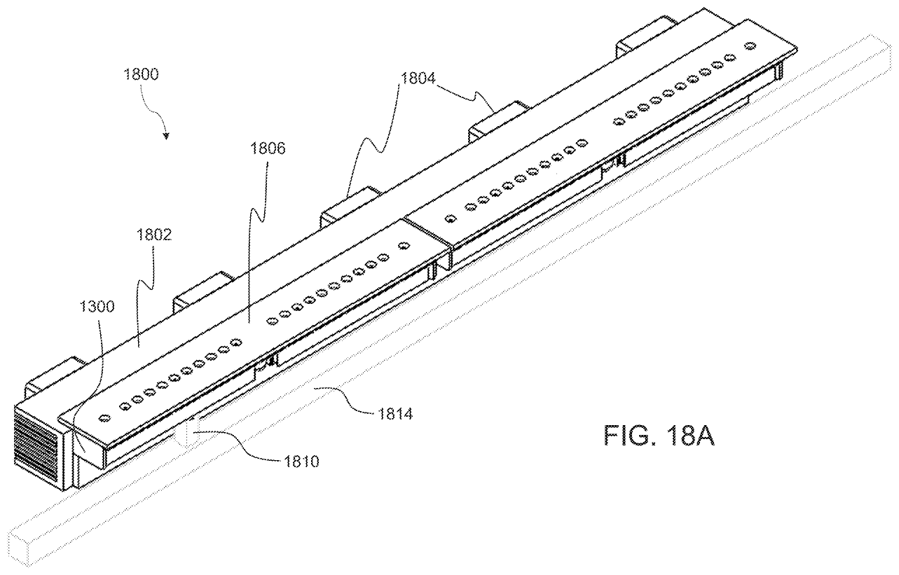

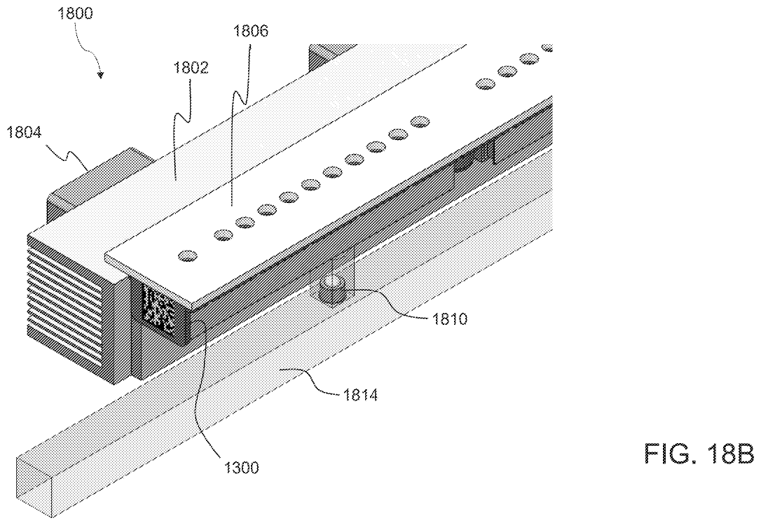

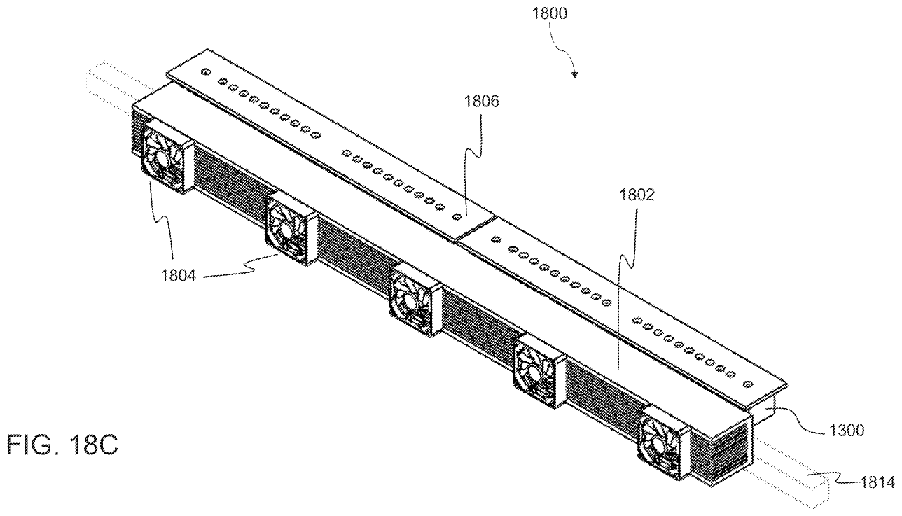

FIGS. 18A-C are diagrams illustrating different views of a PCR cartridge 1300 interfacing with a PCR subsystem 1800 in the analyzer, according to embodiments of the present disclosure. PCR subsystem 1800 represents an exemplary embodiment of PCR subsystem 244 shown in FIG. 3B. In some embodiments, PCR subsystem 1800 may be a module configured to perform PCR of nucleic acids in the PCR cartridge 1300, optical detection of fluorescent signals from the PCR amplification, and identification of pathogens based on the fluorescent signals. In some embodiments, the PCR subsystem 1800 may include one or more thermal blocks, heat sinks 1802, fans 1804, a heating lid 1806, a sensor unit 1810, and a linear translation stage 1814. In some embodiments, the PCR subsystem 1800 may include one or more thermal blocks, thermoelectric cooler (TEC) elements, conductive elements, Peltier cells, and/or the like.

In some embodiments, the PCR cartridge 1300 may be pressed down to ensure contact with a thermal block, which may be a part of a thermal cycler configured to control temperatures when performing nucleic acid amplifications. In some embodiments, the thermal blocks may control temperatures in a range of about 35° C. to 100° C., with a setting resolution of about 0.1° C. In some embodiments, the thermal blocks may have a temperature accuracy of about +0.25° C. with respect to the setting (e.g., steady state). In some embodiments, the temperature ramp rates of the thermal blocks may be greater than about 10 degrees (in ° C.) per second. In some embodiments, the temperature profiles of the thermal blocks may be configured or customized by a user of the analyzer device 200 for performing thermal cycling.

In some embodiments, the PCR subsystem 1800 includes thermoelectric cooler (TEC) elements, a heat sink 1802 and one or more fans 1804 disposed below each of the thermal blocks and below the PCR cartridge 1300. In some embodiments, the TEC elements, heat sinks 1802, and fans 1804 may be used to heat and/or cool down the PCR cartridge 1300 for maintaining specific temperatures during the amplification processes for PCR. In some embodiments, fans 1804 may be distributed along the length of heat sink 1802, as illustrated in FIGS. 18A and 18C. In other embodiments, fans 1804 may be located at one or more ends of heat sink 1802, positioned as an end cap. In some embodiments, the heating lid 1806 may be disposed over the cover 1302 of the PCR cartridge 1300 and over the primary and secondary reaction chambers 1313, 1314. In some embodiments, the heating lid 1806 may be configured to heat upper portions of the at least one primary reaction chamber 1313 and the plurality of secondary reaction chambers 1314 to prevent condensation during thermal cycling in the PCR subsystem 1800. In some embodiments, the heating lid 1806 may control temperatures in a range of about 35° C. to 100° C., with a setting resolution of about 0.1° C. In some embodiments, the heating lid 1806 may have a temperature accuracy of about ±0.25° C. with respect to the setting (e.g., steady state).

In some embodiments, the sensor unit 1810 (shown in FIGS. 18A and 18B) may comprise one or more fluorescence sensors that are configured to perform fluorescent readings from the bottom of the secondary reaction chambers 1314 in the PCR cartridge 1300, through the thermal blocks. In some embodiments, the sensor unit 1810 may be configured to detect fluorescent signals from multiple fluorescence dyes, such as FAM™, VIC®, ROX™, SYBR®, Cy5 (cyanine dyes), Cy5.5 or the like. In some embodiments, the sensor unit 1810 may include one or more optical elements based on solid-state (e.g., LED/PIN diode). In some embodiments, one or more main parameters (e.g., LED power, reading time, etc.) of the sensor unit 1810 may be configurable by software (e.g., installed on processing device 116).

In some embodiments, the linear translation stage 1814 may be a translation stage that allows for positioning/scanning of the sensor unit 1810 below the primary and secondary reaction chambers 1313, 1314 of the PCR cartridge 1300. In some embodiments, the bottom wall of each primary and secondary reaction chamber 1313, 1314 may be optically transparent, such that the sensor unit 1810 may optically interrogate the reaction chambers 1313, 1314 and detect fluorescent signals. In some embodiments, a set of optical fibers may be used to deliver the excitation and collect the emission to/from the primary and secondary reaction chamber 1313, 1314 of the PCR cartridge 1300.

In some embodiments, the entrance of light in the PCR subsystem 1800 may be avoided during thermal cycling. In some embodiments, the PCR cartridge 1300 may be pushed downwards (e.g., by positioning between the thermal blocks and under the heating lid 1806) during operation to ensure optimal thermal contact.

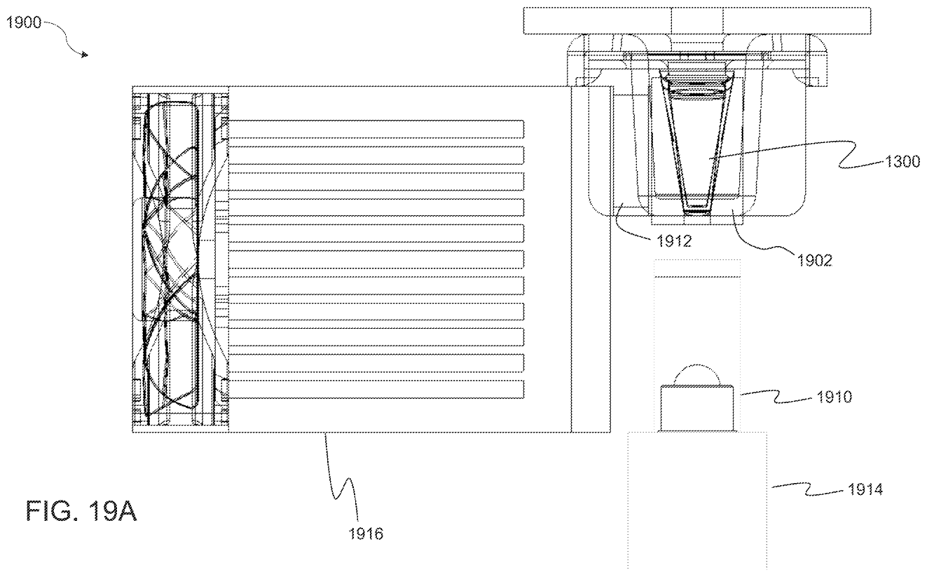

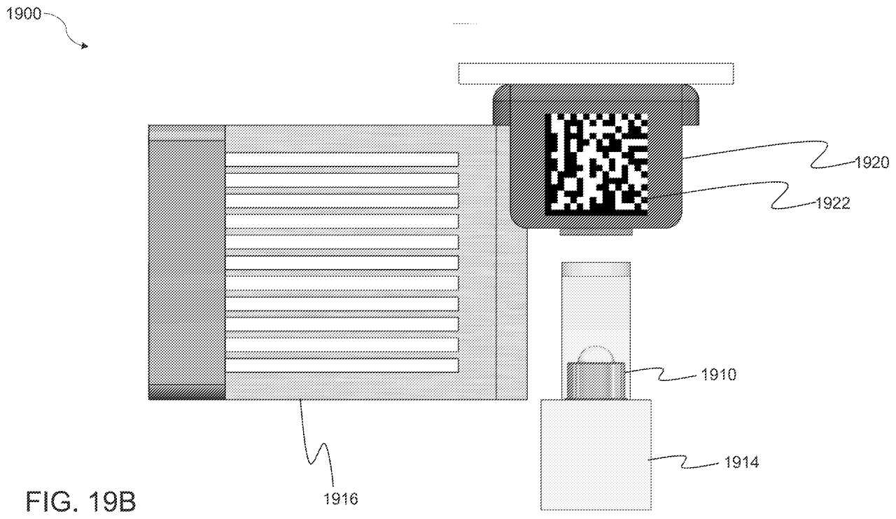

FIGS. 19A-B are diagrams illustrating an example fluorescence sensor subsystem 1900 in the analyzer, according to embodiments of the present disclosure. The fluorescence sensor subsystem 1900 represents an exemplary embodiment of PCR subsystem 1800 shown in FIG. 18. As illustrated in FIG. 19A, the fluorescence sensor subsystem 1900 includes thermal blocks 1902, Peltier cell 1912, heat sink 1916, fluorescence sensor 1910, and linear translation stage 1914. In some embodiments, the PCR cartridge 1300 may be pressed down against the thermal blocks 1902 and adjacent to the Peltier cells 1912. In some embodiments, the fluorescence sensor 1910 may be configured to perform fluorescence readings from the bottom of the secondary reaction chambers 1314 in the PCR cartridge 1300. In some embodiments, at least the thermal blocks 1902 and the Peltier cells 1912 are surrounded by a housing 1920, as illustrated in FIG. 19B. Housing 1920 may include one or more identifiers 1922 containing information regarding the PCR cartridge (e.g., sample identifier, date, etc.).

### Example Methods of Operation

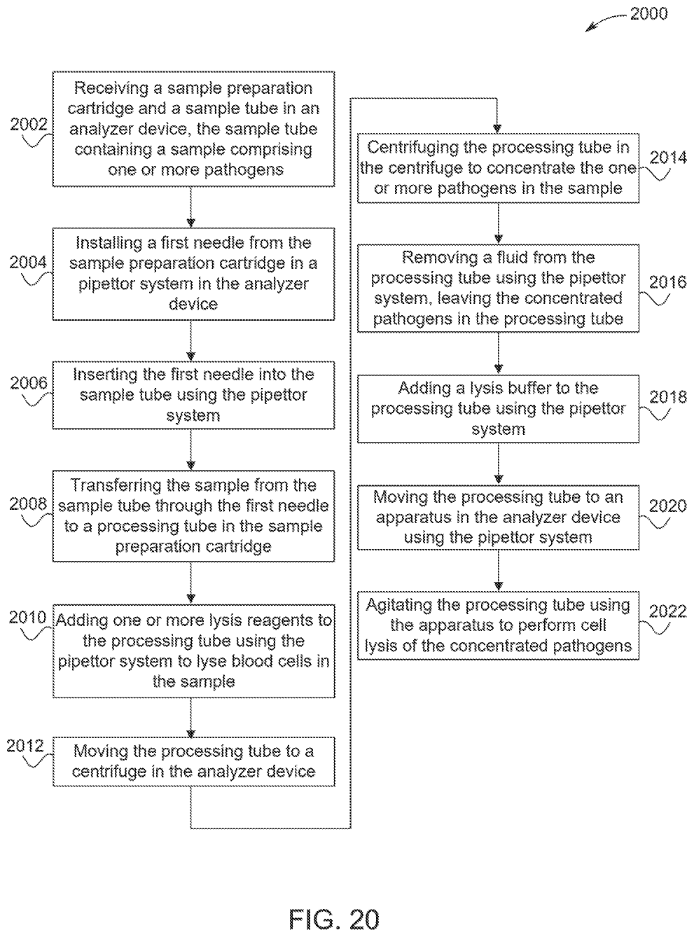

FIG. 20 illustrates a flowchart diagram of a method 2000 for performing sample processing, including concentration and lysis of a sample, before pathogen identification, according to embodiments of the present disclosure. In some embodiments, method 2000 may describe the steps for performing sample processing using various components in the pathogen identification system, including analyzer 108, 200, sample preparation cartridge 114, 224, 500, and processing tube 113, 510, 700, as discussed above with reference to FIGS. 1-19. It should be understood that the operations shown in method 2000 are not exhaustive and that other operations can be performed as well before, after, or between any of the illustrated operations. In various embodiments of the present disclosure, the operations of method 2000 can be performed in a different order and/or vary.

Method 2000 of FIG. 20 begins with step 2002, at which a sample preparation cartridge and a sample tube are received in an analyzer device. In some embodiments, the analyzer device 200 may receive sample preparation cartridge 224 and sample tube, which are placed in the sample cartridge drawer 220 and sample drawer 210, respectively, of the analyzer device 200, by a user or operator of the analyzer device 200. In some embodiments, the sample cartridge drawer 220 and sample drawer 210 may be referred to as a first compartment and a second compartment, respectively, of the analyzer device 200. In some embodiments, the sample tube may be a sample obtained from a patient, in which the sample comprises pathogens. In some embodiments, the sample in the sample tube may comprise whole blood, urine, sterile body fluids, or other samples obtained from the patient.

At step 2004, a first needle from the sample preparation cartridge is installed in a pipettor system in the analyzer device. In some embodiments, needle 512 from the sample preparation cartridge 500 may be installed in the first pipettor 202 by the pipette tip of the first pipettor 202 moving above the sample preparation cartridge 500, pressing and fitting into a plastic body portion of the needle (e.g., plastic body 902).

At step 2006, the first needle is inserted into the sample tube using the pipettor system. In some embodiments, after installation of the needle 512, the first pipettor 202 may move above the sample tube in the sample drawer 210 before pressing down and inserting the needle 512 into the sample tube.

At step 2008, the sample from the sample tube is transferred through the first needle to a processing tube in the sample preparation cartridge. In some embodiments, the needle 512 may draw up the sample into the plastic body reservoir of the first pipettor 202, and the first pipettor 202 may move to the sample preparation cartridge 500 to transfer the sample into a processing tube 510 in the sample preparation cartridge 500.

In order to transfer the sample from the plastic body reservoir of the first or second pipettor 202 to the processing tube 510, the needle 512 (coupled to the first pipettor 202) may pierce through a septum of the processing tube (e.g., septum 704 of processing tube 700). The first pipettor 202 may then dispense the sample to the processing tube through the needle 512.

At step 2010, one or more lysis reagents may be added to the processing tube to lyse blood cells in the sample. In some embodiments, the first pipettor 202 may add one or more lysis reagents, such as a saponin-based lysis buffer, to the processing tube 700 through the needle 512. The one or more lysis reagents may be mixed (e.g., by homogenization subsystem 246) with the sample in the processing tube 700 to lyse blood cells in the sample.

After blood cell lysis, at step 2012, the processing tube is moved to a centrifuge in the analyzer device. In some embodiments, the first or second pipettor 202, 204 may be configured to move the processing tube 700 to first centrifuge 1502 by handling a top end (e.g., cylindrical cavity in the cap 702) of the processing tube 700 that is compatible with the pipettor system. In some embodiments, the pipette tip of the first or second pipettor 202, 204 may press and fit into the cylindrical cavity in the cap 702 to pick up and move the processing tube to the first centrifuge 1502 in the analyzer device 200.

At step 2014, the processing tube is centrifuged in the centrifuge to concentrate the one or more pathogens in the sample. In some embodiments, the processing tube 700 is centrifuged in the first centrifuge 1502 to concentrate the pathogens from a high volume (e.g., 10 mL) to a low volume (e.g., 0.5 mL or less) in the processing tube 700. In some embodiments, a volume of the sample in the sample tube is in a range of about 0.5 mL to about 10 mL, and a volume of the concentrated pathogens in the processing tube 700 after the centrifuging is in a range of about 0.1 mL to about 2 mL. In some embodiments, a volume of the concentrated pathogens in the processing tube after the centrifuging is in a range of about 0.1 mL to about 1 mL.

At step 2016, a fluid from the processing tube is removed using the pipettor system, leaving the concentrated pathogens in the processing tube. In some embodiments, the needle 512 coupled to the first pipettor 202 may collect and remove a fluid from the processing tube 700, leaving behind the concentrated pathogens in the bottom of the processing tube 700. At step 2018, a lysis buffer may be added to the processing tube using the pipettor system. In some embodiments, the needle 512 coupled to the first pipettor 202 may retrieve one or more lysis buffers from the one or more reservoirs 504 in the sample preparation cartridge 500 and dispense the one or more lysis buffers to the processing tube 700 through the needle 512.

In some embodiments, a reagent may be added to the processing tube 700 using the needle 512 coupled to the first pipettor 202 to perform a DNA depletion step before adding the lysis buffer to the processing tube 700. In some embodiments, the reagent used for performing the DNA depletion step may comprise at least one of DNase I (Deoxyribonuclease I), DNase II (Deoxyribonuclease II), or Benzonase.

At step 2020, the processing tube may be moved to an apparatus in the analyzer device using the pipettor system. In some embodiments, the first or second pipettor 202, 204 may move the processing tube 700 to the mechanical apparatus 1700 in the analyzer device 200. In some embodiments, the first or second pipettor 202, 204 may be configured to move the processing tube 700 to mechanical apparatus 1700 by handling a top end (e.g., cylindrical cavity in the cap 702) of the processing tube 700 that is compatible with the pipettor system. In some embodiments, the pipette mandrel of the first or second pipettor 202, 204 may press and fit into the cylindrical cavity in the cap 702 to pick up and move the processing tube to the mechanical apparatus 1700 in the analyzer device 200.

At step 2022, the processing tube may be agitated using the apparatus to perform cell lysis of the concentrated pathogens. In some embodiments, the mechanical apparatus 1700 may apply a fast vibration movement to the processing tube 700 to perform cell lysis of the concentrated pathogens in the processing tube 700. In some embodiments, the mechanical apparatus 1700 may be an agitator. In some embodiments, the processing tube 700 may be held in a vertical position in the agitator. In some embodiments, applying the fast vibration movement may comprise applying a reciprocating movement along a predetermined axis by the agitator. In additional or alternative embodiments, agitating the processing tube 700 may comprise sonicating the processing tube 700 using a sonicator in the analyzer device 200.

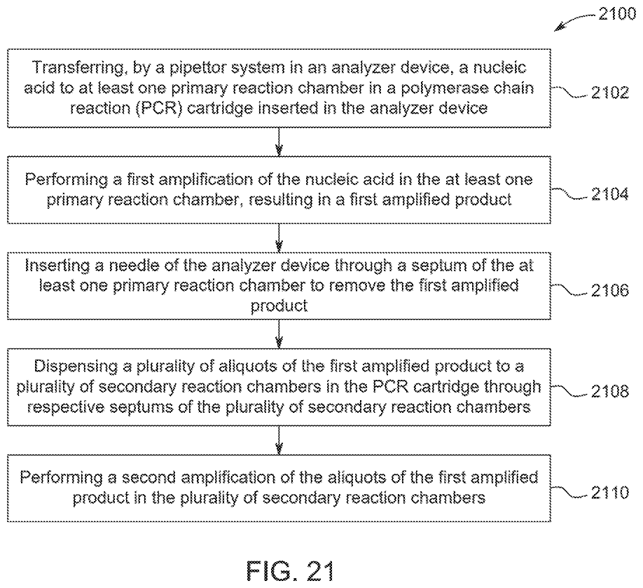

FIG. 21 illustrates a flowchart diagram of a method 2100 for performing PCR for pathogen identification, according to embodiments of the present disclosure. In some embodiments, method 2100 may describe performing PCR for pathogen identification in a PCR cartridge, such as PCR cartridge 234, 1300, as discussed above with reference to FIGS. 3B-19. It should be understood that the operations shown in method 2100 are not exhaustive and that other operations can be performed as well before, after, or between any of the illustrated operations. In various embodiments of the present disclosure, the operations of method 2100 can be performed in a different order and/or vary.

Method 2100 of FIG. 21 begins with step 2102, at which a nucleic acid is transferred, by a pipettor system in an analyzer device, to at least one primary reaction chamber in a PCR cartridge inserted in the analyzer device. In some embodiments, the PCR cartridge 234 may be inserted in the analyzer device 200 when it is placed in the processing cartridge drawer 230 by a user or operator of the analyzer device 200. In some embodiments, the low volume needle 910 coupled to the second pipettor 204 may transfer a nucleic acid after extraction and purification from spin column basket 1102 or from one or more reservoirs 504 of the sample preparation cartridge 500. In some embodiments, the low volume needle 910 coupled to the second pipettor 204 may transfer the nucleic acid to at least one primary reaction chamber 1313 in the PCR cartridge 1300. In some embodiments, the first or second pipettor 202 or 204 may add, to the nucleic acid, a preliminary set of reagents used for nucleic acid amplification in a reagent tube (e.g., reagent tube 710) prior to the transferring of the nucleic acid to the at least one primary reaction chamber 1313 in the PCR cartridge 1300. In some embodiments, the set of reagents used for nucleic acid amplification may be stored within one of the primary reaction chambers 1313 in the PCR cartridge 1300, and may be dispensed to the second primary reaction chamber 1313 for suspending with the nucleic acid in the sample.

At step 2104, a first amplification of the nucleic acid is performed in the at least one primary reaction chamber, resulting in a first amplified product. In some embodiments, first amplification of the nucleic acid is performed in the at least one primary reaction chamber 1313 of the PCR cartridge 1300 using PCR technology. In some embodiments, a set of primers may be transferred to the primary reaction chamber 1313 along with the nucleic acid for the first amplification. In some embodiments, the set of primers may be compatible with an amplification of target sequences to be detected. In some embodiments, different sets of primers may be transferred to the primary reaction chamber 1313 along with the nucleic acid for the first amplification. In some embodiments, a combination of the different sets of primers may be compatible with an amplification of target sequences to be detected.

At step 2106, a needle of the analyzer device is inserted through a septum of the at least one primary reaction chamber to remove the first amplified product. In some embodiments, the low volume needle 910 coupled to the second pipettor 204 may be inserted through septum 1308 disposed over the primary reaction chamber 1313 to collect the first amplified product from the primary reaction chamber 1313 of the PCR cartridge 1300.

At step 2108, a plurality of aliquots of the first amplified product is dispensed to a plurality of secondary reaction chambers in the PCR cartridge through respective septums of the plurality of secondary reaction chambers. In some embodiments, the plurality of aliquots of the first amplified product may be dispensed by inserting the low volume needle 910 coupled to the second pipettor 204 through the septum(s) 1308 to the plurality of secondary reaction chambers 1314 in the PCR cartridge 1300. In some embodiments, each aliquot may correspond to a respective secondary reaction chamber 1314 in the PCR cartridge 1300. In some embodiments, the aliquot of the first amplified product from the primary reaction chamber 1313 may be diluted with the contents of one of the reservoirs 504 of sample preparation cartridge 500.

In some embodiments, each secondary reaction chamber 1314 may comprise a set of reagents for reacting with the respective aliquot of the first amplified product. In some embodiments, the set of reagents in each secondary reaction chamber 1314 may correspond to inner sequences of amplicons in the first amplified product and may be specific to one or more target sequences to be detected. In some embodiments, the set of reagents in each secondary reaction chamber 1314 may comprise fluorescent probes that are specific to one or more target sequences to be detected.

In some embodiments, the first or second pipettor 202 or 204 may add, to the first amplified product, a preliminary set of reagents used for nucleic acid amplification in a reagent tube (e.g., reagent tube 710) prior to the dispensing of the plurality of aliquots of the first amplified product to the secondary reaction chambers 1314 in the PCR cartridge 1300. In some embodiments, the dispensing of the plurality of aliquots to the plurality of secondary reaction chambers 1314 may include using jet dispensing to perform a contactless dispensing of the aliquots by the needle 910 penetrating the respective septums 1308 of the secondary reaction chambers 1314 and without the needle 910 contacting a bottom surface of each secondary reaction chamber 1314.

At step 2110, a second amplification of the aliquots of the first amplified product is performed in the plurality of secondary reaction chambers. In some embodiments, the second amplification of aliquots of the first amplified product is performed in the plurality of secondary reaction chambers 1314 of the PCR cartridge 1300 using PCR technology.

In some embodiments, fluorescence at the bottom of each secondary reaction chamber 1314 may be detected by the PCR subsystem 1800 to monitor the second amplification and PCR and detect the amplified nucleic acid. In some embodiments, the processing device 116 may receive, from PCR subsystem 1800, fluorescence data from monitoring the second amplification and the PCR workflow. In some embodiments, the processing device 116 may then use the fluorescence data to detect the amplified nucleic acid in the secondary reaction chambers 1314 and identify a pathogen present in the sample of the patient based on the detected amplified nucleic acid.

### EXPERIMENTAL EXAMPLES

As discussed below, several experiments were performed to test various embodiments of the pathogen ID systems and methods described above.

### Example 1: Optimization of the Sample Preparation and DNA Extraction Protocol

The experiments shown in this example were performed to improve DNA purification by increasing buffer extraction volumes, and are representative of certain embodiments disclosed in this patent application.

10 mL of human whole blood was spiked with 1 CFU/mL concentration of K. pneumoniae, and the following sample treatment was performed:

The K. pneumoniae spiked blood was transferred to a 15 ml conical tube (processing tube) already containing 0.7 mL of saponin 2.8% w/v (Sigma-Aldrich, S4521), 0.5 mL cushioning agent FC-40 (Sigma-Aldrich, F9755), and a zirconia-silica bead mix containing: 0.25 mL of 0.1 mm+0.25 mL of 0.5 mm+10 beads of 1 mm and 3-4 beads of 2.7 mm diameter. Blood and reagents were mixed on the PTR-35 platform under rotatory orbital movement for 30 seconds at speed of 10 rpm (five turn overs) for blood cells homogenization and lysis. To separate supernatant from the rest, the sample was centrifuged at 12000×g for 10 minutes in the fixed angle rotor FA-45-6-30 in a 5810 Eppendorf centrifuge. Holding the tube vertically, the supernatant was removed carefully and discarded leaving in the tube a total volume of 1 mL comprising bead mix, cushion, and concentrated blood sample.

To test pathogen DNA purification improvement, tests increasing lysis buffer and or binding buffer volume were performed.

Lysis buffer was homogenized, and different volumes of buffer (0.45 mL and 0.9 mL) were added to the mix of beads and sample. Test conditions were briefly mixed by vortex for 5 seconds. Next, the sample tubes were secured on a custom agitation platform (reciprocating movement, 2 degrees, 16.000 rpm), which was turned on for 30 seconds to lyse the sample. 4 pulses of 30 seconds, waiting 5 seconds between them, were performed for a total of 2 min of lysis. During this process the tube was kept in a vertical position. Once mechanical lysis was over, sample tubes were centrifuged for 5 min at 3200× g in a swing out bucket rotor A-4-62, to separate beads and cell debris from the lysate. Maintaining the tube in an upright position, the lysate was transferred and mixed with different volumes (1 mL and 2 mL) of binding buffer thoroughly by pipetting. Two spin columns per test condition were used, and 0.5 mL of lysate was loaded on each column and centrifuged for 1 minute at 10000× g (FA 24×2 rotor). This step was repeated until all the lysate passed through the column. Spin columns were washed twice with 0.5 mL of wash buffer, centrifuged for 1 minute at 10000× g and dried by centrifuging for 2 minutes at 13000× g. Spin columns were transferred to a 1.5 mL tube and 60 μL of elution Buffer was loaded onto them. Samples were incubated for 5 minutes at room temperature to ensure proper DNA contact with Elution Buffer and optimal DNA recovery and then centrifuged for 1 minute at 10000× g. The volumes of the two elutes obtained in the two columns which belonged to the same sample were mixed in one final tube. It is noted that this process can be considered as equivalent to using a single spin column with a binding surface equal to the sum of the binding surfaces of the individual spin columns used in this experiment.

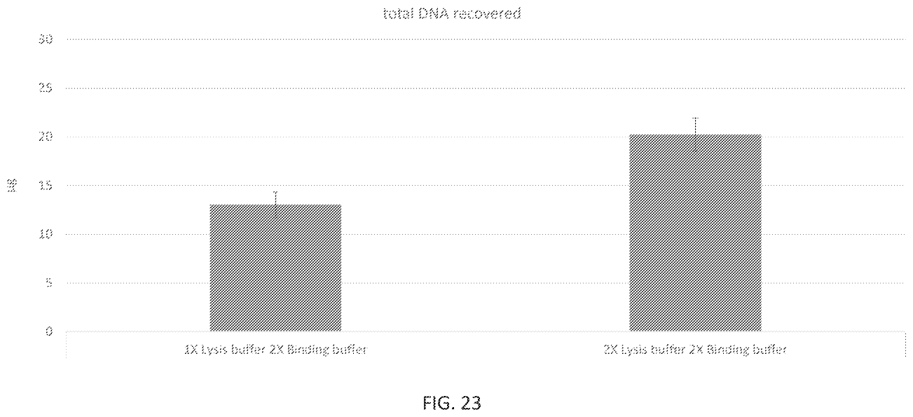

Results are shown in FIG. 23. These results indicate that increasing the volumes of both lysis buffer and binding buffer improves extracted DNA quantity.

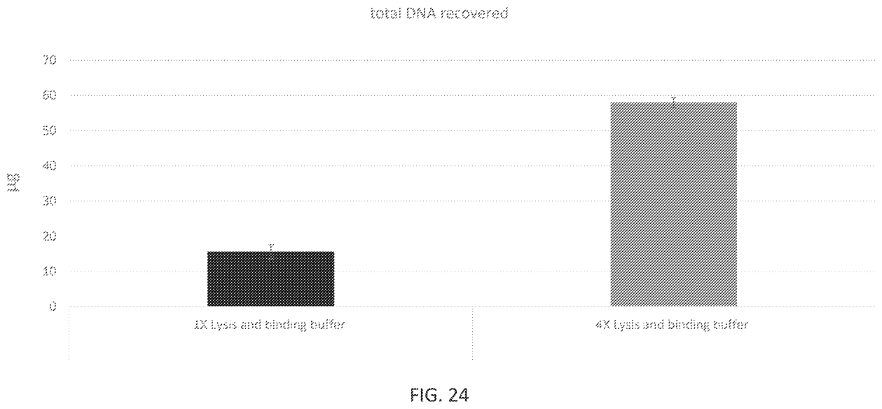

Based on the observed results, in another example, lysis buffer and binding buffer volumes were increased ×4 times compared to the nominal volumes (1.8 mL and 4 mL respectively) and the sample preparation protocol shown above was performed. Results presented on FIG. 24 show an increase in the amount of total DNA obtained compared to the protocol using the nominal lysis buffer volume. Besides, pathogen detection occurred 1 Ct earlier than in samples processed using the recommended volume of buffers.

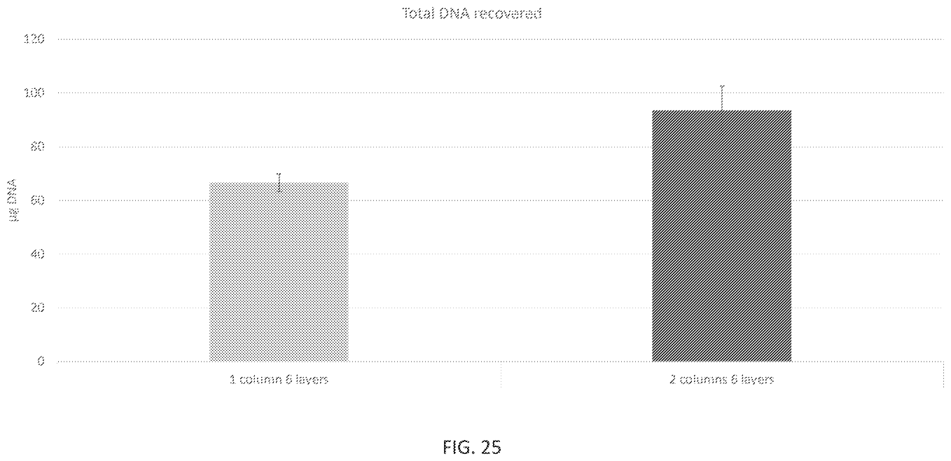

As every single column is composed of three silica membranes in this example, and two columns improved the yield of the extraction, the number of layers of the spin column was changed from 3 to 6 in order to increase the total DNA obtained. In this assay all conditions tested yielded a good DNA quality and no differences were observed related to pathogen detection. However, a slightly lower DNA amount was obtained from those samples processed using a 6 layered column. In another experiment, two columns of 6 layers were used and the yields were higher compared to the ones using only one column of 6 layers, as illustrated in FIG. 25. As a conclusion the more columns and silica layers used, that is the more DNA binding surface, the higher amount of DNA is recovered.

### Example 2: Use of a Single Tip in Sample Preparation to Perform an End-to-End Protocol

This example illustrates how the operations disclosed in the methods of this patent can be carried out using a single device for transferring the fluids along all the operations In embodiments of the disclosed method, this may be performed with a needle. In this test example, this was simulated with a single pipette tip.

10 mL of human whole blood spiked with 1.3 CFU/mL concentration of K. pneumoniae were added to a sample tube containing 0.7 mL of 2.8% saponin (w/v), 0.5 mL Fluorinert™ FC-40, and a mixture of zirconia-silica beads consisting of 0.25 mL 0.1 mm beads, 0.25 mL 0.5 mm beads, 10 beads of 1 mm and 2-3 beads of 2.7 mm. Blood and reagents were mixed on the PTR-35 platform under rotatory orbital movement for 30 seconds at speed of 10 rpm (five turn overs) for blood cells homogenization and lysis. Pathogens were collected by centrifuging at 12000× g for 10 minutes in a fixed angle rotor. Holding the tube vertically, the supernatant was removed carefully and discarded leaving in the tube a total volume of 1 mL comprising bead mix, cushion, and concentrated blood sample.

All steps of addition of buffers and supernatant removal were performed using the same pipette filter tip (Eppendorf Ref. 30078624), in order to simulate in the laboratory the conditions met by embodiments of the device disclosed herein, where all handling steps are performed using a single needle. Before addition of wash buffer, the pipette tip was rinsed with 2.5 mL or 5 mL of elution buffer for comparison. Addition of 60 μL elution buffer to each spin column was also performed with the same used and rinsed pipette tip.

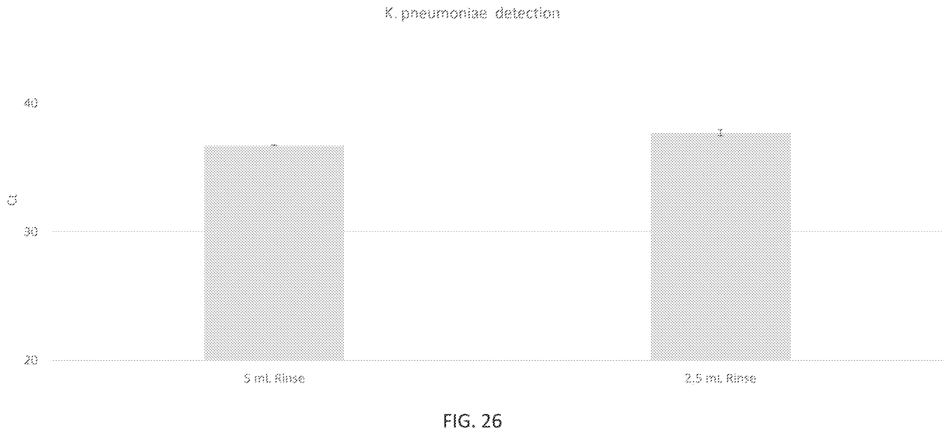

For results comparison real time PCR was performed. As a summary, results as shown in FIG. 26 show no significant differences in PCR detection (obtained Ct values) between samples whose pipette filter tip was rinsed using 2.5 mL or 5 mL elution buffer volume. Detection Ct values obtained using only one tip for sample preparation are comparable to those observed in other experiments where multiple filter tips were used.

### Example 3: Sample preparation and DNA extraction for high-sensitive detection by PCR

In the following example, a whole blood pool was spiked with an inoculum of a microorganism (bacteria or yeast) at a known concentration. Depending on the growth characteristics of the tested microorganism, the inoculum was prepared from an exponential culture or from a microbial suspension from a fresh strike on an agar plate.

10 mL of spiked whole blood were transferred to a 15 ml conical tube already containing 0.7 mL of saponin 2.8% w/v (Sigma-Aldrich, S4521), 0.5 mL cushioning agent FC-40 (Sigma-Aldrich, F9755), and a zirconia-silica bead mix containing: 0.25 mL of 0.1 mm+0.25 mL of 0.5 mm+10 beads of 1 mm and 3-4 beads of 2.7 mm diameter. Blood and reagents were mixed on the PTR-35 platform under rotatory orbital movement for 30 s at speed of 10 rpm (five turn overs) for blood cells homogenization and lysis. Pathogens were collected by centrifuging at 12000× g for 10 minutes in a fixed angle rotor. Holding the tube vertically, the supernatant was removed carefully and discarded leaving in the tube a total volume of 1 mL comprising bead mix, cushion, and concentrated blood sample.

Lysis buffer was homogenized, and 1.8 mL were added to the mix of beads and sample, and briefly mixed by vortex for 5 seconds. Next, the sample tubes were secured on a custom agitation platform (reciprocating movement, 2 degrees, 16.000 rpm) which was turned on for 30 seconds at speed 1 to perform bead beating to lyse the sample. 4 pulses of 30 seconds, waiting 5 seconds between them, were performed for a total of 2 minutes of lysis. During this process the tube was kept in a vertical position. Once mechanical lysis was over, sample tubes were centrifuged for 5 minutes at 3200× g in a swing out bucket rotor, to separate beads and cell debris from the lysate. Maintaining the tube in an upright position, the lysate was transferred and mixed with 4 mL of binding buffer thoroughly by pipetting. Two spin columns per sample were used, and 0.5 mL of lysate were loaded on each column and centrifuged for 1 minute at 10000× g (FA 24×2 rotor). This step was repeated until all the lysate passed through the column. Spin columns were washed twice with 0.5 mL of wash buffer, centrifuged for 1 minute at 10000× g and dried by centrifuging for 2 minutes at 13000× g. Spin columns were transferred to a 1.5 mL tube and 60 μL of elution buffer was loaded onto it. Samples were incubated for 5 minutes at room temperature to ensure proper DNA contact with elution buffer and optimal DNA recovery, and then centrifuged for 1 minute at 10000× g. The volumes of the two elutes obtained in the two columns which belonged to the same test condition was mixed in one final tube.

In order to confirm specific pathogen recovery after sample preparation, detection was performed in a singleplex PCR reaction containing specific primer pairs and probes for the spiked pathogen. Each reaction included the following: 50 μL of 2× TaqPath Bactopure Microbial detection Master Mix (ThermoFisher Scientific), 0.9 μM Fw primer, 0.9 μM Rv primer, 0.25 μM probe and 50 μL of the elution obtained in previous step (see explanation above). Cycling conditions were the following: 2 minutes at 95° C. followed by 45 cycles of 10 seconds at 95° C. and 30 seconds at 60° C. for annealing and extension. A pre-read and a post-read step at 60° C. were included.

The microorganisms shown in the table below were tested following this PCR procedure, including Gram-positive, Gram-negative bacteria and yeast, several of them considered as difficult to lyse. Results are shown in Table 1 below (Table 1). It can be observed that pathogens can be detected at concentrations in order of a few CFU/mL, which is in the range of sensitivity required for the detection of pathogens in bloodstream infections.

TABLE 1
Spiked concentration

| Pathogen | CFU/mL | Detection Rate |
|---|---|---|
| A. baumannii | 1.6 | 2/4 |
| C. albicans | 0.6 | 4/4 |
| C. glabrata | 1.5 | 4/4 |
| E. coli | 2.2 | 4/4 |
| E. faecalis | 1.7 | 4/4 |
| E. faecium | 1.8 | 4/4 |
| H. influenzae | 0.5 | 0/4 |
| K. pneumoniae | 1.3 | 4/4 |
| P. aeruginosa | 1.5 | 4/4 |
| S. aureus | 1.5 | 7/8 |
| S. pneumoniae | 1.9 | 4/4 |

### Example 4: Detection of S. Aureus in Samples Containing High White Blood Cells Counts (WBC)

Human DNA is a strong interfering substance which can act as a potential PCR inhibitor. Normal leukocyte counts range from 3 to 11×10E6 white blood cells/mL of blood in a healthy adult. In a septic patient leukocyte count can be overwhelmingly increased.

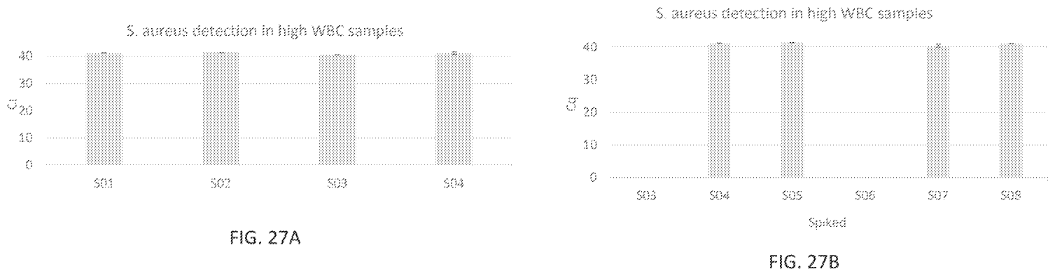

To test PCR performance in a context of elevated WBC counts, 10 mL of blood containing high white blood cell numbers (20-30×10E6 leukocytes/mL) was spiked with 1.3 CFU/mL concentration of S. aureus (13 CFU/tube). The sample was processed as stated in the former examples and pathogen detection through PCR was performed in a singleplex manner. FIGS. 27A-B show results obtained. 4/6 replicates of the S. aureus spiked sample were detected.

### Example 5: Two-Stage Multiplex PCR for Detection of Low Concentrated in Presence of High Concentrated Pathogens

In Example 5, 100 genome copies of P. aeruginosa (low concentration) were combined with high concentration of S. aureus, S. pneumoniae and H. Influenzae. Detection of 100 genome copies/rxn of P. aeruginosa in an increasing DNA background of 10E4, 10E5, 10E6 genome copies/rxn for the rest of the mentioned pathogens, was assessed in a two-stage PCR format. As primary reaction chambers, 0.2 mL PCR strips were used. 25 μL of PCR volume was used at each amplification stage. The primary PCR consisted of 20 cycles of a PCR mix containing primers pairs for detection of all the mentioned pathogens.

A PCR reaction mixture of 25 μL was prepared by mixing 12.5 μL of 2× TaqPath Bactopure Microbial detection Master Mix (ThermoFisher Scientific), 0.36 μM of each primer, 5 μl of sample and water. The following cycling conditions were applied in this first PCR: 2 minutes at 95° C. followed by 20 cycles of 10 seconds at 95° C. and 30 seconds for annealing and extension.

At the end of the primary PCR the amplified product of the primary PCR reactions was extracted with a pipette and aliquoted in secondary reaction chambers.

The secondary PCR was performed in 0.2 mL PCR strips. Secondary PCR was performed in a final volume of 25 μL using Prime Time Gene Expression Master Mix (IDT), 0.36 μM of each primer and 0.25 μM of probe targeting the oprL gene from P. aeruginosa. 5 μL volume of the primary PCR reaction was used as template for the secondary PCR. Cycling conditions were: 3 minutes at 95° C. followed by 45 cycles of 5 seconds at 95° C. and 30 seconds at 60° C. for annealing and extension.

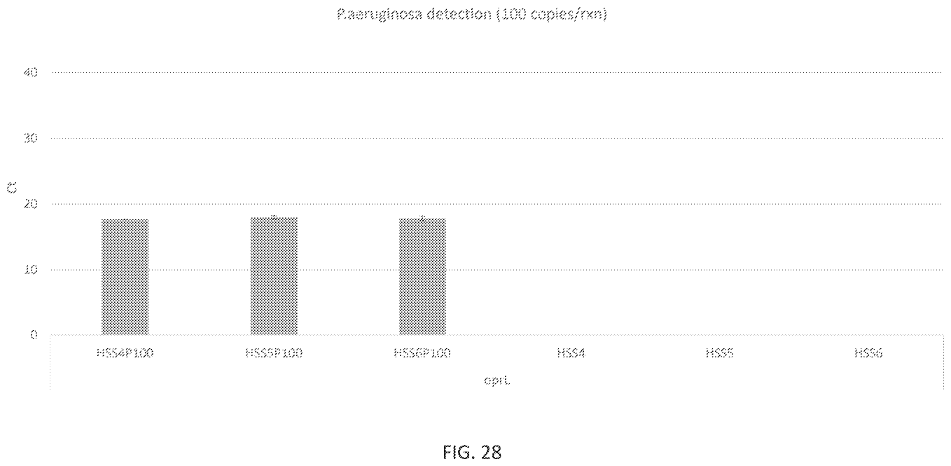

FIG. 28 shows detection of P. aeruginosa target (Ct values) from the 2nd stage PCR. No amplification P. aeruginosa is observed in Controls including DNA of the high concentrated samples but in absence of P. aeruginosa DNA, indicating that the observed amplification signal is pathogen specific. In FIG. 28, HSS4P100 makes reference to H. influenzae, S. pneumoniae, S. aureus at 10E4 copies/rxn each and P. aeruginosa at 10E2 copies/rxn, HSS5P100 makes reference to H. influenzae, S. pneumoniae, S. aureus at 10E5 copies/rxn each and P. aeruginosa at 10E2 copies/rxn, and HSS6P100 makes reference to H. influenzae, S. pneumoniae, S. aureus at 10E6 copies/rxn each and P. aeruginosa at 10E2 copies/rxn, HSS4, HSS5 and HSS6 are Controls and make reference to H. influenzae, S. pneumoniae, S. aureus at 10E4, 10E5, and 10E6 copies/rxn respectively. No amplification of P. aeruginosa was expected in these test conditions.

### Example 6: Effect in performance due to PCR product dilution between the first-stage and second-stage PCR

In Example 6, the effect of diluting first stage PCR products before the second stage PCR was assessed using the same pathogen mix combination shown above (low concentration of P. aeruginosa combined with high concentration of S. aureus, S. pneumoniae and H. influenzae). Detection of 10 or 100 genome copies of P. aeruginosa in an increasing DNA background of 10E4, 10E5, 10E6 genome copies for the rest of these mentioned pathogens, was assessed in a two-stage PCR. 25 μL of PCR volume was used at each amplification stage. Two-stage PCR consisted of 20 cycles of a first PCR containing primers pairs for detection of all the pathogens above mentioned and using 2× TaqPath Bactopure Microbial detection Master Mix (ThermoFisher Scientific). The following cycling conditions were applied in this first PCR: 2 minutes at 95° C. followed by 20 cycles of 10 seconds at 95° C. and 30 seconds for annealing and extension.

The following dilutions of PCR product obtained in the first stage PCR were prepared (⅕, 1/20 and 1/200) and loaded in the second stage PCR.

The second stage PCR was performed as a singleplex PCR containing primers and probe for the detection of the oprL gene for P. aeruginosa and 2× Prime Time Gene Expression Master Mix (IDT). 5 μL volume of the first stage PCR reaction were used as template for second stage PCR. Cycling conditions were: 3 minutes at 95° C. followed by 45 cycles of 5 seconds at 95° C. and 30 seconds at 60° C. for annealing and extension.

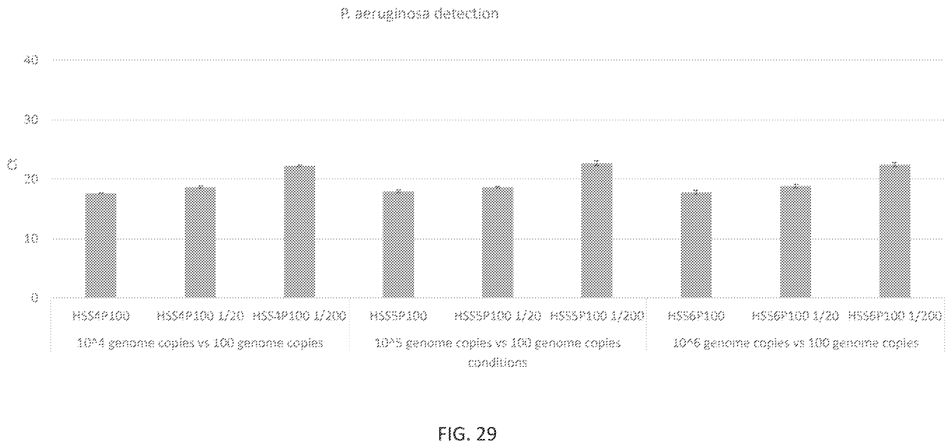

Results are shown in FIG. 29. In FIG. 29, HSS4P10 makes reference to H. influenzae, S. pneumoniae, S. aureus at 10E4 copies/rxn each and P. aeruginosa at 10E2 copies/rxn, HSS5P100 makes reference to H. influenzae, S. pneumoniae, S. aureus at 10E5 copies/rxn each and P. aeruginosa at 10E2 copies/rxn. As a summary, slight Ct differences were observed between the non-diluted and the diluted condition for the 1/20 condition. Regarding the 1/200 dilution condition, 4 Cts of difference were observed between the non-diluted and the diluted condition.

### Example Computer System

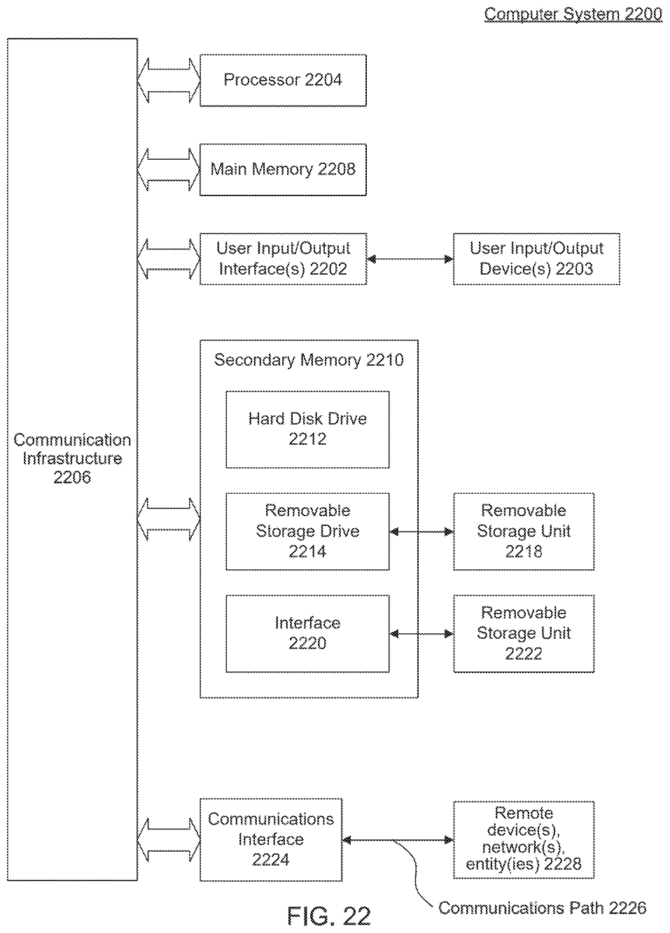

FIG. 22 is a block diagram of example components of computer system 2200. One or more computer systems 2200 may be used, for example, to implement any of the embodiments discussed herein, as well as combinations and sub-combinations thereof. In some embodiments, one or more computer systems 2200 may be used to perform fluorescence data and/or image acquisition, data analysis, and data processing, such as for the fluorescence sensor subsystem in the PCR subsystem 1800, or the processing device 116, as described herein. In some embodiments, one or more computer systems 2200 may also be used in the controller 109 for programming and operating movements of various components in the analyzer device 200. Computer system 2200 may include one or more processors (also called central processing units, or CPUs), such as a processor 2204. Processor 2204 may be connected to a communication infrastructure or bus 2206.

Computer system 2200 may also include user input/output interface(s) 2202, such as monitors, keyboards, pointing devices, etc., which may communicate with communication infrastructure 2206 through user input/output device(s) 2203.

One or more of processors 2204 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 2200 may also include a main or primary memory 2208, such as random access memory (RAM). Main memory 2208 may include one or more levels of cache. Main memory 2208 may have stored therein control logic (i.e., computer software) and/or data. In some embodiments, main memory 2208 may include optical logic configured to perform sepsis detection, sepsis likelihood prediction, pathogen identification, and susceptibility testing, and generate recommendations for treatment of patients accordingly.

Computer system 2200 may also include one or more secondary storage devices or memory 2210. Secondary memory 2210 may include, for example, a hard disk drive 2212 and/or a removable storage drive 2214.

Removable storage drive 2214 may interact with a removable storage unit 2218. Removable storage unit 2218 may include a computer usable or readable storage device having stored thereon computer software (control logic) and/or data. Removable storage unit 2218 may be a program cartridge and cartridge interface (such as that found in video game devices), a removable memory chip (such as an EPROM or PROM) and associated socket, a memory stick and USB port, a memory card and associated memory card slot, and/or any other removable storage unit and associated interface. Removable storage drive 2214 may read from and/or write to removable storage unit 2218.

Secondary memory 2210 may include other means, devices, components, instrumentalities or other approaches for allowing computer programs and/or other instructions and/or data to be accessed by computer system 2200. Such means, devices, components, instrumentalities or other approaches may include, for example, a removable storage unit 2222 and an interface 2220. Examples of the removable storage unit 2222 and the interface 2220 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 2200 may further include a communication or network interface 2224. Communication interface 2224 may enable computer system 2200 to communicate and interact with any combination of external devices, external networks, external entities, etc. (individually and collectively referenced by reference number 2228). For example, communication interface 2224 may allow computer system 2200 to communicate with external or remote devices 2228 over communications path 2226, which may be wired and/or wireless (or a combination thereof), and which may include any combination of LANs, WANs, the Internet, etc. Control logic and/or data may be transmitted to and from computer system 2200 via communication path 2226.

Computer system 2200 may also be any of a personal digital assistant (PDA), desktop workstation, laptop or notebook computer, netbook, tablet, smartphone, smartwatch or other wearables, appliance, part of the Internet-of-Things, and/or embedded system, to name a few non-limiting examples, or any combination thereof.

Computer system 2200 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 2200 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 2200, main memory 2208, secondary memory 2210, and removable storage units 2218 and 2222, as well as tangible articles of manufacture embodying any combination of the foregoing. Such control logic, when executed by one or more data processing devices (such as computer system 2200), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 22. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

1. A sample preparation cartridge comprising:
a housing;
a removable processing tube disposed inside the housing and comprising a septum and configured to hold a sample;
a first removable needle disposed inside the housing and configured to transfer the sample to and/or from the removable processing tube by insertion of the first removable needle through the septum; and
one or more reservoirs coupled to the housing and configured to store materials used for performing sample concentration, lysis, and nucleic acid amplification.

2. The sample preparation cartridge of claim 1, further comprising at least one of:
a protective lid configured to cover the housing and the one or more reservoirs; and
one or more spin columns configured to perform extraction and purification of a nucleic acid from the sample.

3. (canceled)

4. The sample preparation cartridge of claim 2, further comprising:
a basket or receptacle with the one or more spin columns disposed inside, wherein the one or more spin columns are configured to move to an elution position to obtain the nucleic acid from the sample.

5. The sample preparation cartridge of claim 1, wherein at least one of the one or more reservoirs is configured to store magnetic beads for extraction and purification of a nucleic acid from the sample.

6. The sample preparation cartridge of claim 1, further comprising:
a reagent tube configured to hold a first set of reagents used for the nucleic acid amplification.

7. The sample preparation cartridge of claim 6, wherein the reagent tube and/or the one or more reservoirs are sealed with aluminum foil.

8. The sample preparation cartridge of claim 1, wherein the septum in the removable processing tube is disposed at a top end of the removable processing tube, and wherein a plurality of lysis beads are disposed within the removable processing tube for performing the lysis.

9. The sample preparation cartridge of claim 8, wherein the plurality of lysis beads comprise a plurality of predetermined sizes and materials configured to perform lysis of at least one of the following pathogens: yeast, fungi, gram-positive bacteria, or gram-negative bacteria.

10. The sample preparation cartridge of claim 1, wherein the first removable needle is a venting needle comprising a cannula and a plastic body attached to the cannula, wherein the venting needle is configured to vent the removable processing tube.

11. The sample preparation cartridge of claim 10, wherein the plastic body of the venting needle comprises at least one of:
a filter configured to prevent contamination; and
a predetermined number of slots configured to provide an air connection between an inside and an outside of the removable processing tube when the venting needle is inserted through the septum into the removable processing tube.

12. (canceled)

13. The sample preparation cartridge of claim 10, wherein the first removable needle comprises a cannula arranged around an inner core.

14. The sample preparation cartridge of claim 10, wherein the cannula of the venting needle comprises a slotted cannula.

15. The sample preparation cartridge of claim 10, wherein the cannula of the venting needle is in fluid communication with a venting hole.

16. The sample preparation cartridge of claim 1, further comprising:
a second removable needle configured to transfer a nucleic acid to a second cartridge for the nucleic acid amplification.

17. The sample preparation cartridge of claim 16, wherein the first removable needle is configured to be coupled to a higher volume pipettor, and wherein the removable second needle is configured to be coupled to a lower volume pipettor.

18. The sample preparation cartridge of claim 17, wherein the higher volume pipettor is configured to handle a volume in a range of about 50 microliters to 5 milliliters.

19. The sample preparation cartridge of claim 17, wherein the lower volume pipettor is configured to handle a volume in a range of about 1 to 200 microliters.

20. The sample preparation cartridge of claim 1, wherein the removable processing tube comprises a handling feature at a top end of the removable processing tube that is compatible for handling by a pipettor coupled to the first removable needle.

21. The sample preparation cartridge of claim 20, wherein the handling feature comprises a cap having a cylindrical cavity that is compatible for insertion by a mandrel of the pipettor coupled to the first removable needle, wherein the cap is positioned above the septum at the top end of the removable processing tube.

22. A system for analyzing samples, comprising:
a housing configured to receive a sample tube containing a sample comprising one or more pathogens;
a pipettor system disposed inside the housing;
one or more centrifuges disposed inside the housing;
a mechanical agitator disposed inside the housing; and
a controller, wherein the controller is configured to:
transfer the sample from the sample tube to a processing tube using the pipettor system;
centrifuge the processing tube using the one or more centrifuges to concentrate the one or more pathogens in the sample;
remove a fluid from the processing tube using the pipettor system, leaving the concentrated pathogens in the processing tube;
add a lysis buffer to the processing tube using the pipettor system;
move the processing tube to the mechanical agitator using the pipettor system; and
agitate the processing tube using the mechanical agitator to perform cell lysis of the concentrated pathogens.

23-62. (canceled)

63. A polymerase chain reaction (PCR) cartridge comprising:
at least one primary reaction chamber configured to perform a first amplification of a nucleic acid, resulting in a first amplified product; and
a plurality of secondary reaction chambers configured to perform a second amplification of the product nucleic acid, wherein the at least one primary reaction chambers and the plurality of secondary reaction chambers are each sealed with a septum, wherein the septum is configured to receive a needle, each secondary reaction chamber in the plurality of secondary reaction chambers is configured to receive a respective aliquot of the first amplified product from the needle, and each secondary reaction chamber comprises a set of reagents for reacting with the respective aliquot of the first amplified product.

64-71. (canceled)

72. The sample preparation cartridge of claim 10, wherein a proximal end of the plastic body of the first removable needle is configured to couple to a pipettor.
